(19) United States
(12) Patent Application Publication
(10) Pub. No.: US 2017/0130447 A1
(43) Pub. Date: May 11, 2017

(54) Portable Modularized Medical Unit and System

(71) Applicants: John R. Lane, JR., San Antonio, TX (US); James Richard Knight, San Antonio, TX (US)

(72) Inventors: John R. Lane, JR., San Antonio, TX (US); James Richard Knight, San Antonio, TX (US)

(21) Appl. No.: 14/935,895

(22) Filed: Nov. 9, 2015

(51) Int. Cl. E04B 1/343; E04H 1/12; A61G 1/013

(52) U.S. Cl. CPC E04B 1/34336; A61G 1/013; E04H 1/12; E04H 2001/1283

(57) ABSTRACT

The invention includes a portable modularized medical unit that may be transported by airplane, helicopter, truck, rail, or ship to and from any location where emergency medical care, trauma care, surgical care, intensive care, isolation care, critical care, mass casualty, exam treatment or emergency medical evacuation are needed. The unit includes a rigid parallelepipedal frame that serves as the rigid exoskeleton of the unit that is a rigid aluminum parallelepipedal frame with a plurality of longitudinal metal tracks in the unit to provide the attachment or connection points for various medical components inside the internal portion of the portable modularized medical unit and that are rigidly attached to the interior surface of the base structure of the rigid parallelepipedal frame to provide multiple connection and attachment points for the components in an airworthy but removable manner to the base structure, walls, or roof of the rigid parallelepipedal frame so that the components internal to the unit may be attached, removed, relocated, replaced, and rearranged inside of the portable modularized medical unit.

### CROSS-REFERENCE TO RELATED APPLICATIONS

This application is based on Provision Application Ser. No. 62/077,208, filed Nov. 8, 2014.

### STATEMENTS REGARDING FEDERALLY SPONSORED RESEARCH OR DEVELOPMENT

NA

### REFERENCE TO A MICROFICHE APPENDIX

NA

### BACKGROUND OF THE INVENTION

1. Field of the Invention

The present invention is generally directed to portable modularized medical units and a system for rapid reconfiguration and reuse of such units. Specifically, this invention relates to self-contained, portable modularized medical units that may be transported by airplane, helicopter, truck, rail, or ship to almost any location where emergency medical care, trauma care, surgical care, intensive care, isolation care, or emergency medical evacuation are required. Transportable medical units have great utility because medical emergencies, epidemic disease outbreaks, and mass casualty events often occur in remote locations that are not in close proximity to modern medical facilities. Moreover, even in developed areas where permanent medical facilities exist, such emergencies, outbreaks, and mass casualty events may occur after or simultaneously with the destruction or degradation of the permanent medical facilities that are located in the area. Transportable medical units allow for modern medical care and treatment to be transported on an as needed basis to such remote locations or to such devastated areas where nearby permanent medical facilities are no longer available or not functioning adequately. The portable modularized medical units of this invention allow for necessary medical personnel and medical equipment to be moved rapidly to such remote locations or to such devastated areas, thereby allowing patients in those locations or areas to promptly receive the medical care and treatment that they need. The portable modularized medical units of this invention also may be used for emergency medical evacuation of injured or sick patients from such remote locations or devastated areas. Moreover, the portable modularized medical units are designed not only to be used on-site at or near to the remote locations or devastated areas, but also for the provision of medical care and treatment to patients while the portable modularized medical units are inside the cargo hold of a cargo transport vehicle while the cargo transport vehicle is either stationary or during transport to or from such remote locations or devastated areas. The installation of the portable modularized medical units in (or onto) cargo transport vehicles such as cargo airplanes, cargo helicopters, cargo ships, flatbed trucks, or flatbed rail cars effectively temporarily converts the cargo transport vehicles into mobile ambulances or mobile hospitals that may be moved to the location or area where emergency medical evacuation, emergency trauma care, surgical care, or isolation ward care are needed, and then subsequently after such emergency medical evacuation or onsite medical care is no longer necessary, the removal of the portable modularized medical units from the cargo hold of the cargo transport vehicles allows the cargo transport vehicles to be repurposed for non-medical use.

2. Description of the Related Art

Mobile hospital units are known in the art. For example, U.S. Pat. No. 4,425,978 and U.S. Pat. No. 4,570,733 provide for a standard cargo container to be permanently reconstructed into a single mobile hospital unit configuration for providing emergency medical treatment to injured survivors at the site of a disaster. These patents teach that such mobile hospital units contain storage for medical equipment and contain multiple stretcher beds for treatment and transport of patients. These patents further teach that such mobile hospital units contain an engine and four-wheel drive providing autonomous surface transportability. However, the mobile hospital units provided for by these patents are dedicated, permanently reconstructed cargo containers that have one basic, fixed arrangement of internal elements, and therefore they lack the versatility of the modularized medical units and system provided for herein.

Portable medical diagnostic suites are also known in the art. For instance, U.S. Pat. No. 5,727,353 provides for an ISO approved shipping container to be permanently modified into a portable medical diagnostic suite containing at least one medical diagnostic device, such as an MM, X-ray machine, or CT scanner. This patent teaches that such portable medical diagnostic suite may be transported by truck, train, boat or airplane. The medical diagnostic device and other medical equipment provided for in this patent are permanently mounted in the portable medical diagnostic suite. The medical diagnostic suite taught by this patent has a fixed arrangement of internal elements, and therefore lacks the versatility of the modularized medical units and system provided for herein.

Transportable medical complexes are also known in the art. For instance, U.S. Pat. No. 4,458,864 provides for a transportable medical complex consisting of an emergency surgical suite that can be installed in a standard cargo helicopter. The emergency surgical suite contained within the transportable medical complex of this patent is able to operate both on the ground and while in flight. The transportable medical complex taught by this patent has adjustable dimensions and does not have a rigid outer body, but does have permanently affixed internal elements. The emergency surgical suite lacks the durability and rigidity of the modularized medical units provided for herein, and also lacks the versatility through interchangeability of internal elements of the modularized medical units provided for herein. Moreover, the capacity and efficiency of the transportable medical complexes and the emergency surgical suites taught by this patent are limited by the maximum dimensions provided for the transportable medical complexes, whereas the portable modularized medical units disclosed herein provide for more efficient, coordinated treatment of patients by health care providers while on-site or during transport.

There are other transportable medical units that exist in the prior art. For example, mobile CT units mounted inside semi-truck trailers that are capable of ground-based transport from location to location are used with some regularity. The prior art also includes transportable dental stations that have been built inside oversea transport containers in which internal elements such as a dentist's chair, oral X-ray device, patient chair, and tooth washing equipment are permanently affixed to the floor and walls of the container. Other transportable medical units exist in which the units expand outwards by means of sliding walls or pole and tenting type structures. To the extent that these transportable medical units include medical equipment, it is typically rigidly and permanently affixed to the structure of the units. Further, many of these transportable medical units require significant amounts of time to set up after delivery to the location or area where medical care is to be provided to patients. These transportable medical units also typically lack a sturdy structure that stands up well to the rigors of repeated transport to and from remote locations.

### BRIEF SUMMARY OF THE INVENTION

The present invention is generally directed to portable modularized medical units.

The invention includes a portable modularized medical unit that may be transported by airplane, helicopter, truck, rail, or ship to and from any location where emergency medical care, trauma care, surgical care, intensive care, isolation care, critical care, mass casualty, exam treatment or emergency medical evacuation are needed. The unit includes a rigid parallelepipedal frame that serves as the rigid exoskeleton of the unit that is a rigid aluminum parallelepipedal frame comprised of a base structure, a wall framework comprised of at least four walls, at least one door disposed within one of the walls and a roof. A plurality of longitudinal metal tracks in the unit provide the attachment or connection points for various medical components inside the internal portion of the portable modularized medical unit and that are rigidly attached to the interior surface of the base structure of the rigid parallelepipedal frame to provide multiple connection and attachment points for the components in an airworthy but removable manner to the base structure, walls, or roof of the rigid parallelepipedal frame so that the components internal to the unit may be attached, removed, relocated, replaced, and rearranged inside of the portable modularized medical unit.

The longitudinal metal tracks run the entire length of the inner surface of the base structure, or they may only run the majority of the length of the base structure without completely extending from distal end to distal end of the unit. A lock on the underside of the base structure of the rigid aluminum parallelepipedal frame locks the unit into place utilizing and aircraft cargo handling system that is provided within the cargo hold of a cargo transport aircraft that is to be used by the end user to transport the portable modularized medical unit on am airworthy manner.

Aircraft quality, sound resistant dampening and insulation material is installed in the portable modularized medical unit that reduces external noise outside of the unit during transport to an internal acoustical level of less than 75 decibels and maintain climate control.

The unit has an electrical power converter that may be connected via one or more ports disposed within a wall of the rigid parallelepipedal frame to an electrical power supply of a cargo transport aircraft when the unit is loaded into the cargo hold of an cargo transport aircraft or to another power supply when transported or on the ground. The unit is constructed of lightweight materials such as aluminum.

The tracks will secure any combination of removable components such as medical equipment, a chair, closable partition wall, computer terminal kiosk, critical care medical beds, curtain partitions, desk chairs, lab table which contains internal storage space for medical equipment, lavatory with sink, medical equipment shelving unit, medical equipment storage closet, medical equipment storage cupboards, medical litter stretchers, medical litter support racks, medical personnel seating, radiological medical diagnostic equipment, diagnostic equipment, monitoring equipment, storage cabinet, wall mounted desks or work benches with medical equipment storage in the unit in an airworthy manner.

Components are mounted in an airworthy manner in the unit to provide for emergency medical care, trauma care, surgical care, intensive care, isolation care, emergency medical evacuation; exam care, mass casualty, critical care treatment. The dimensions and weight of unit make it capable of being transported within the cargo hold of either an aircraft such as a C-17 or a C-130 transport aircraft. Climate control equipment is mounted on or in the unit to maintain comfortable climate control of the interior of the unit.

### BRIEF DESCRIPTION OF THE SEVERAL VIEWS OF THE DRAWINGS

FIG. 1 is a plan view of a medical evacuation embodiment of the portable modularized medical units of this invention. In FIG. 1 the roof of the unit's rigid parallelepipedal frame has been removed and is not shown such that there is a plan view of the arrangement of components within the internal portion of the unit such as medical litter stretchers, critical care medical beds, medical equipment storage compartments, radiological diagnostic equipment, tables, medical personnel chairs, lavatory and sinks that are provided in the medical evacuation embodiment of the invention.

FIG. 2 is a section view of a mass casualty embodiment of the portable modularized medical units of this invention. The section line for FIG. 2 is taken through the longitudinal center of the unit such that the section view presented in FIG. 2 shows the arrangement of components on the left-hand side of the internal portion of a mass casualty embodiment of the unit. This section view shows the arrangement of components on the left side of a mass casualty embodiment such as medical litter stretchers, medical litter support racks, medical equipment storage compartments, and medical personnel seating.

FIG. 3 is a perspective view of a mass casualty embodiment of the portable modularized medical units of this invention. In FIG. 3 the roof and walls of the unit's rigid parallelepipedal frame have been removed and are not shown such that FIG. 3 affords a perspective view of the arrangement of components within the internal portion of the whole unit such as medical litter stretchers, medical litter support racks, medical equipment storage compartments, and medical personnel seating.

FIG. 3A is a plan view of an alternative mass casualty embodiment of the portable modularized medical units of this invention. In FIG. 3A the roof of the unit's rigid parallelepipedal frame has been removed and is not shown such that there is a plan view of the arrangement of components within the internal portion of the unit such as medical litter stretchers, medical litter support racks, critical care medical beds, medical equipment storage compartments, medical personnel seating, lavatory and sink, and computer terminal kiosk that are provided in the alternative mass casualty embodiment of the invention.

FIG. 4 is a section view of a critical care embodiment of the portable modularized medical units of this invention. The section line for FIG. 4 is taken through the longitudinal center of the unit such that the section view presented in FIG. 4 shows the arrangement of components on the left-hand side of the internal portion of a critical care embodiment of the unit. This section view shows the arrangement of components on the left side of a critical care embodiment of the unit such as medical equipment storage compartments, critical care medical beds, medical personnel seating, and computer terminal kiosks.

FIG. 5 is a section view of a critical care embodiment of the portable modularized medical units of this invention. The section line for FIG. 5 is taken through the longitudinal center of the unit such that the section view presented in FIG. 5 shows the arrangement of components on the right-hand side of the internal portion of a critical care embodiment of the unit. This section view shows the arrangement of components on the right side of a critical care embodiment of the unit such as medical equipment storage compartments, critical care medical beds, medical personnel seating, and computer terminal kiosks.

FIG. 6 is a perspective view of a critical care embodiment of the portable modularized medical units of this invention. In FIG. 6 the roof and walls of the unit's rigid parallelepipedal frame have been removed and are not shown such that FIG. 6 affords a perspective view of the arrangement of components within the internal portion of the whole unit such as medical equipment storage compartments, critical care medical beds, medical personnel seating, and computer terminal kiosks.

FIG. 6A is a plan view of an alternative critical care embodiment of the portable modularized medical units of this invention. In FIG. 6A the roof of the unit's rigid parallelepipedal frame has been removed and is not shown such that there is a plan view of the arrangement of components within the internal portion of the unit such as critical care medical beds, medical equipment storage compartments, medical personnel seating, lavatory and sink, and computer terminal kiosk that are provided in the alternative critical care embodiment of the invention.

FIG. 7 is a section view of a critical care isolation ward embodiment of the portable modularized medical units of this invention. The section line for FIG. 7 is taken through the longitudinal center of the unit such that the section view presented in FIG. 7 shows the arrangement of components on the left-hand side of the internal portion of a critical care isolation ward embodiment of the unit. This section view shows the arrangement of components on the left side of a critical care isolation ward embodiment such as medical equipment storage compartments, sinks, critical care medical beds, medical personnel seating, and computer terminal kiosks.

FIG. 8 is a section view of a critical care isolation ward embodiment of the portable modularized medical units of this invention. The section line for FIG. 8 is taken through the longitudinal center of the unit such that the section view presented in FIG. 8 shows the arrangement of components on the right-hand side of the internal portion of a critical care isolation ward embodiment of the unit. This section view shows the arrangement of components on the right side of a critical care isolation ward embodiment such as medical equipment storage compartments, sinks, critical care medical beds, medical personnel seating, and computer terminal kiosks.

FIG. 9 is a perspective view of a critical care isolation ward embodiment of the portable modularized medical units of this invention. In FIG. 9 the roof and walls of the unit's rigid parallelepipedal frame have been removed and are not shown such that FIG. 9 affords a perspective view of the arrangement of components within the internal portion of the whole unit such as medical equipment storage compartments, sinks, critical care medical beds, medical personnel seating, and computer terminal kiosks.

FIG. 9A is a plan view of an alternative critical care isolation ward embodiment of the portable modularized medical units of this invention. In FIG. 9A the roof of the unit's rigid parallelepipedal frame has been removed and is not shown such that there is a plan view of the arrangement of components within the internal portion of the unit such as critical care medical beds, medical equipment storage compartments, medical personnel seating, lavatory and sink, and computer terminal kiosk that are provided in the alternative critical care isolation ward embodiment of the invention.

FIG. 10 is a section view of an exam treatment embodiment of the portable modularized medical units of this invention. The section line for FIG. 10 is taken through the longitudinal center of the unit such that the section view presented in FIG. 10 shows the arrangement of components on the left-hand side of the internal portion of an exam treatment embodiment of the unit. This section view shows the arrangement of components on the left side of an exam treatment embodiment of the unit such as medical equipment storage compartments, critical care medical beds, medical personnel seating, tables, wall-mounted desks, and medical litter stretchers mounted on a medical litter support rack and partially surrounded by a curtain partition.

FIG. 11 is a section view of an exam treatment embodiment of the portable modularized medical units of this invention. The section line for FIG. 11 is taken through the longitudinal center of the unit such that the section view presented in FIG. 11 shows the arrangement of components on the right-hand side of the internal portion of the an exam treatment embodiment of the unit. This section view shows the arrangement of components on the left side of an exam treatment embodiment such as medical equipment storage compartments, critical care medical beds, patient waiting room seating, tables, wall-mounted desks, and medical litter stretchers mounted on a medical litter support rack and partially surrounded by a central curtain partition.

FIG. 12 is a perspective view of an exam treatment embodiment of the portable modularized medical units of this invention. In FIG. 12 the roof and walls of the unit's rigid parallelepipedal frame have been removed and are not shown such that FIG. 12 affords a perspective view of the arrangement of components within the internal portion of the whole unit such as medical equipment storage compartments, critical care medical beds, patient waiting room seating, medical personnel seating, tables, wall-mounted desks, and two sets of medical litter stretchers mounted on medical litter support racks, each of which is partially surrounded by a separate curtain partition.

FIG. 12A is a plan view of an alternative exam treatment embodiment of the portable modularized medical units of this invention. In FIG. 12A the roof of the unit's rigid parallelepipedal frame has been removed and is not shown such that there is a plan view of the arrangement of components within the internal portion of the unit such as medical litter stretchers, medical litter support racks, critical care medical beds, patient waiting room seating, medical personnel seating, tables, wall-mounted desks, medical equipment storage compartments, medical personnel seating, and lavatory and sink that are provided in the alternative exam treatment embodiment of the invention.

FIG. 13 is a section view of a mixed mass casualty/critical care embodiment of the portable modularized medical units of this invention. The section line for FIG. 13 is taken through the longitudinal center of the unit such that the section view presented in FIG. 13 shows the arrangement of the components on the right-hand side of the internal portion of a mixed mass casualty/critical care embodiment of the unit. This section view shows the arrangement of the components on the right side of a mixed mass casualty/critical care embodiment such as medical equipment storage compartments, a critical care medical bed, a medical equipment shelving unit, a medical equipment closet, and medical personnel seating.

FIG. 14 is a section view of a mixed mass casualty/critical care embodiment of the portable modularized medical units of this invention. The section line for FIG. 14 is taken through the longitudinal center of the unit such that the section view presented in FIG. 14 shows the arrangement of components on the left-hand side of the internal portion of a mixed mass casualty/critical care embodiment of the unit. This section view shows the arrangement of the components on the left side of a mixed mass casualty/critical care embodiment such as medical equipment storage compartments, a critical care medical bed, medical personnel seating, computer terminal kiosk, and two sets of medical litter stretchers mounted on medical litter support racks.

FIG. 15 is a perspective view of a mixed mass casualty/critical care embodiment of the portable modularized medical units of this invention. In FIG. 15 the roof and walls of the unit's rigid parallelepipedal frame have been removed and are not shown such that FIG. 15 affords a perspective view of the arrangement of components within the internal portion of the whole unit such as medical equipment storage compartments, critical care medical beds, medical personnel seating, computer terminal kiosk, and medical litter stretchers mounted on medical litter support racks.

FIG. 16 is a perspective view of an embodiment of the portable modularized medical unit as viewed by an observer from outside of such an embodiment of the portable modularized medical unit. The perspective view of FIG. 16 illustrates that the unit's rigid parallelepipedal frame serves as a rigid exoskeleton for the portable modularized medical unit, but will have at least one, and possibly more than one, door disposed within the wall framework of the rigid parallelepipedal frame that allow ingress into, and egress out of, the internal portion of the portable modularized medical unit.

### DETAILED DESCRIPTION OF THE INVENTION

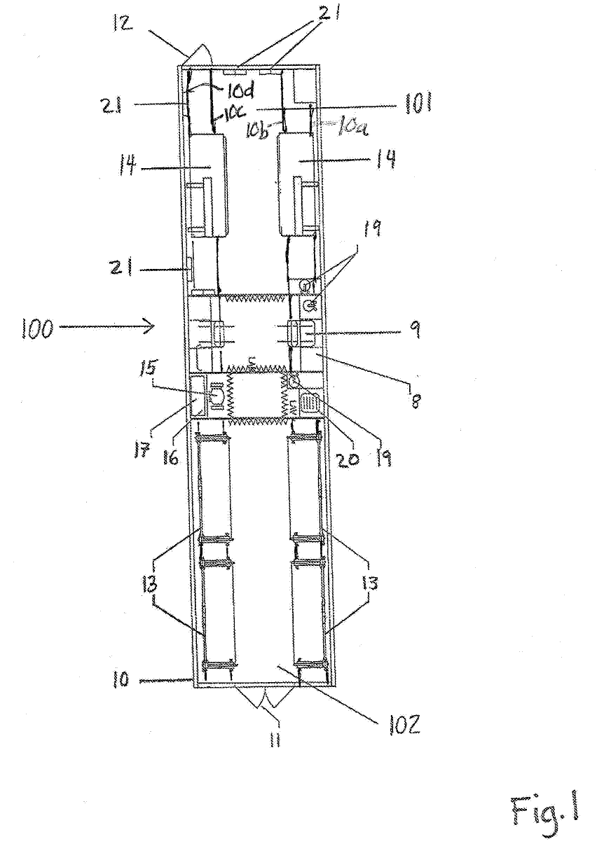

FIG. 1 illustrates the portable modularized medical unit of the present invention in a medical evacuation embodiment 100. The medical evacuation embodiment 100 comprises a rigid parallelepipedal frame 10 with a base structure, a wall framework comprised of at least four walls, and a roof that all cooperate to serve as a rigid exoskeleton of the portable modularized medical unit. In one embodiment of the unit, the rigid parallelepipedal frame 10 is made of aluminum and is built with dimensions such that it will fit within the known maximum cargo hold dimensions of either a C-17 or C-130 cargo transport aircraft. The medical evacuation embodiment 100 of the present invention has double doors 11 disposed within at least one wall of the rigid parallelepipedal frame that provide access into and out of a general patient transport area 102 that contains multiple medical litter stretchers 13. A total of up to twelve medical litter stretchers 13 can be placed within the general patient transport area 102, with the medical litter stretchers 13 stacked in groups of three on top of medical litter support racks (not illustrated) that are positioned along the right and left walls of the general patient transport 11 area 102. The medical evacuation embodiment 100 also further comprises a critical care room 101 at its opposite end. Access from outside of the rigid parallelepipedal frame 10 to the critical care room 101 inside may be had through a door 12 disposed within a wall of the frame 10 on a distal end of the medical evacuation embodiment 100. The critical care room 101 contains two critical care medical beds 14, medical personnel seating 21, and a combination sink and medical equipment storage compartment 19. In the middle of the medical evacuation embodiment 100, there is located at least one lab table 18 which contains internal storage space for medical equipment, at least one chair 9 for medical personnel to sit at while working, two combination sink and medical equipment storage compartments 19, a lavatory for patients and medical personnel 20, radiological medical diagnostic equipment 15, such as an X-ray machine, a processing unit 16 for the radiological medical diagnostic equipment 15, and another compartment for medical equipment storage 17.

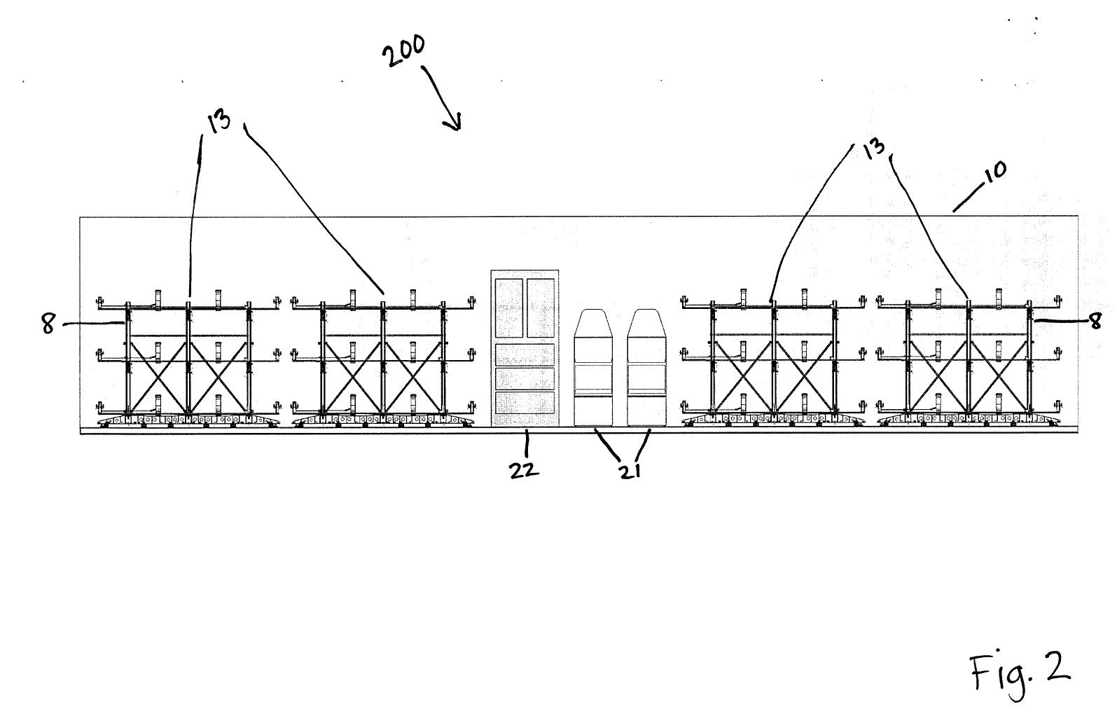

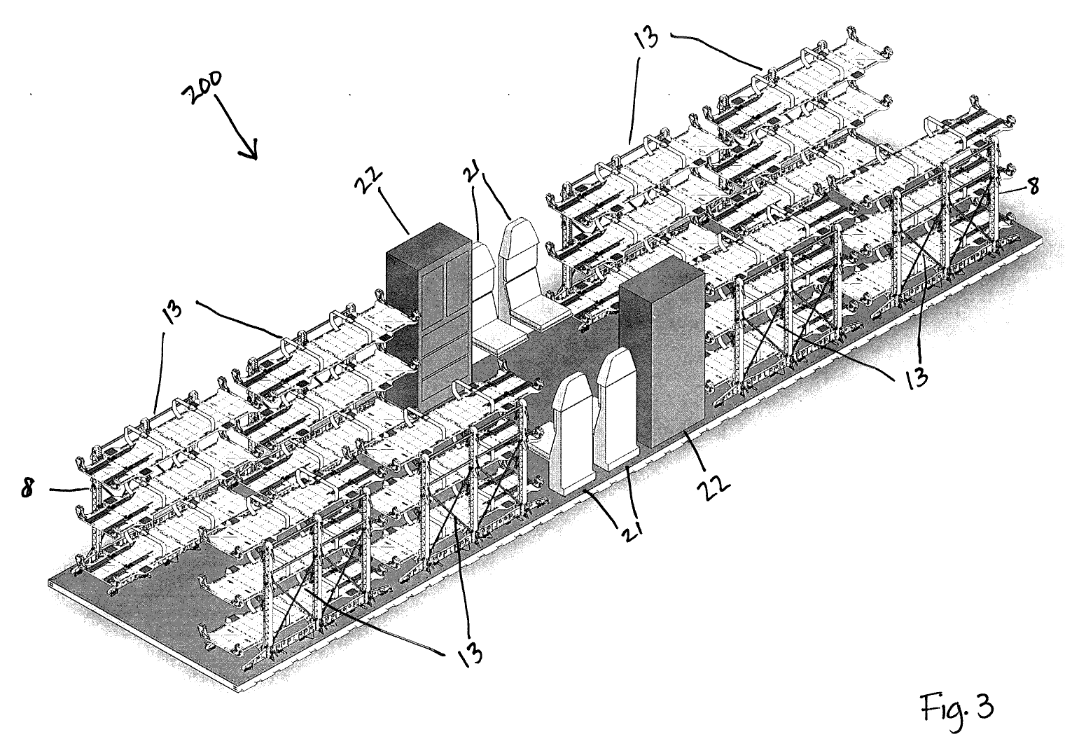

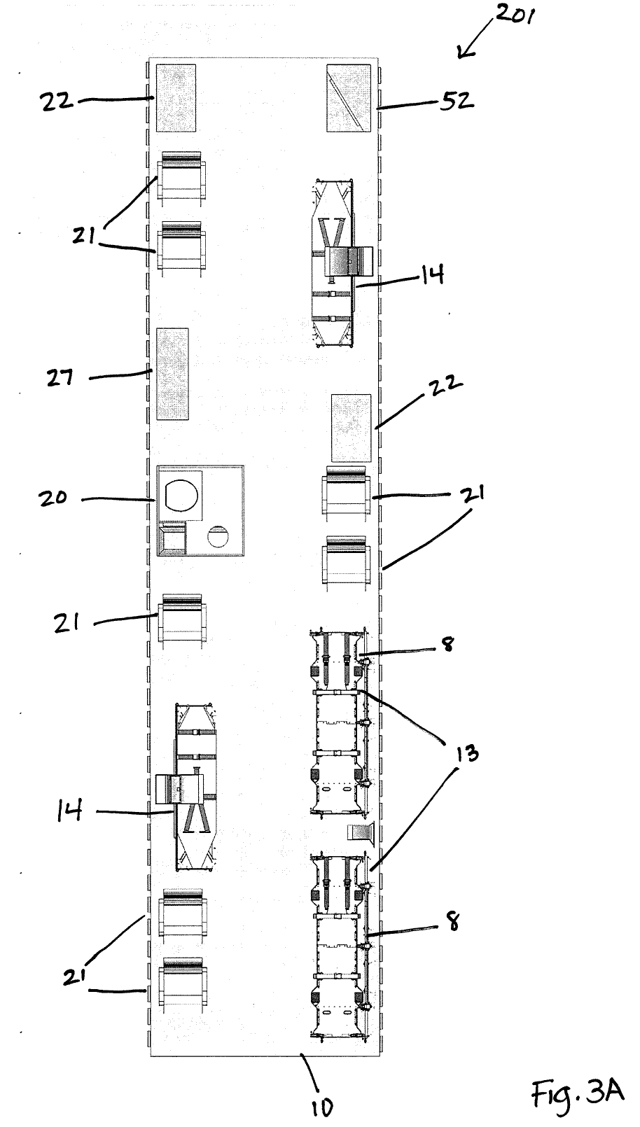

FIG. 2 and FIG. 3 illustrate the portable modularized medical unit of the present invention in a mass casualty embodiment 200. The mass casualty embodiment 200 comprises a rigid parallelepipedal frame 10 with a base structure, a wall framework comprised of at least four walls, and a roof that all cooperate to serve as a rigid exoskeleton of the portable modularized medical unit. In one embodiment of the unit, the rigid parallelepipedal frame 10 is made of aluminum and is built with dimensions such that it will fit within the known maximum cargo hold dimensions of either a C-17 or C-130 cargo transport aircraft. The mass casualty embodiment 200 of the present invention has at least one door (not illustrated) disposed within at least one wall of the frame 10 that provides access to the internal portion of the mass casualty embodiment 200 where medical care and treatment are rendered to patients. The mass casualty embodiment 200 is designed to accommodate up to twenty four medical litter stretchers 13, which are mounted in groups of three apiece on medical litter support racks 8, with accommodation for up to eight total medical litter support racks 8 along the walls of the mass casualty 12 embodiment 200. The mass casualty embodiment 200 also has medical personnel seating 21 for up to four medical personnel, and one or more medical equipment storage cupboards 22.

FIG. 3A illustrates the portable modularized medical unit of the present invention in an alternative mass casualty embodiment 201. The alternative mass casualty embodiment 201 comprises a rigid parallelepipedal frame 10 with a base structure, a wall framework comprised of at least four walls, and a roof that all cooperate to serve as a rigid exoskeleton of the portable modularized medical unit. In one embodiment of the unit, the rigid parallelepipedal frame 10 is made of aluminum and is built with dimensions such that it will fit within the known maximum cargo hold dimensions of either a C-17 or C-130 cargo transport aircraft. The alternative mass casualty embodiment 201 of the present invention has at least one door (not illustrated) disposed within at least one wall of the frame 10 that provides access to the internal portion of the alternative mass casualty embodiment 201 where medical care and treatment are rendered to patients. The alternative mass casualty embodiment 201 is designed to accommodate up to six medical litter stretchers 13, which are mounted in two groups of three apiece on medical litter support racks 8. The alternative mass casualty embodiment 201 also has medical personnel seating 21 for up to six medical personnel, two critical care medical beds 14, a lavatory with sink 20, a computer terminal kiosk 52, and one or more medical equipment storage cupboards 22, and a medical equipment storage closet 27.

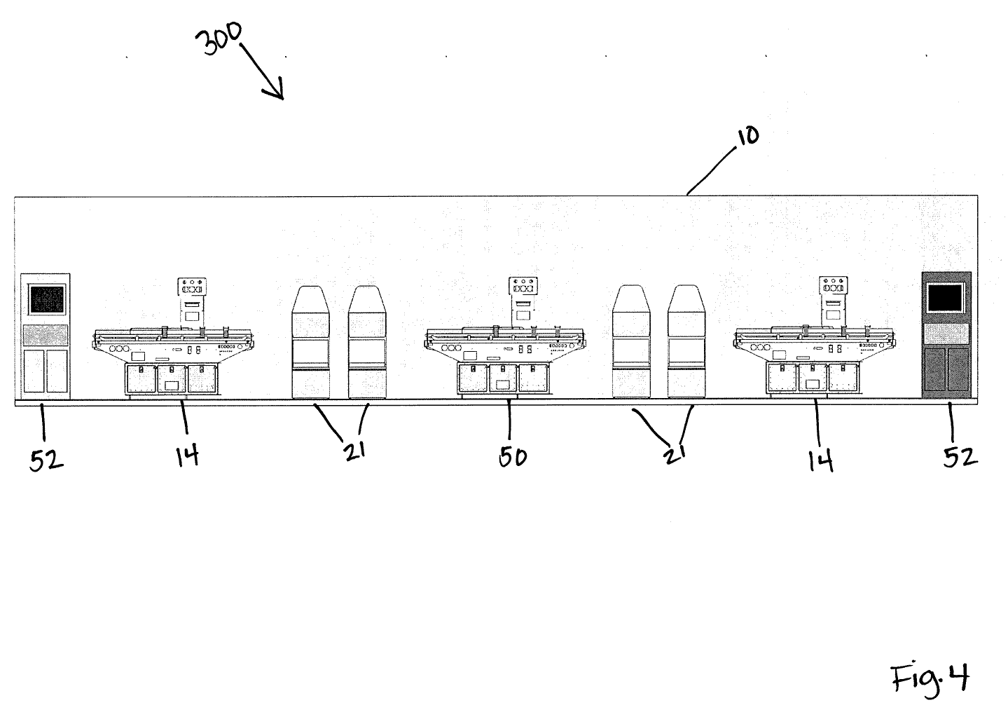

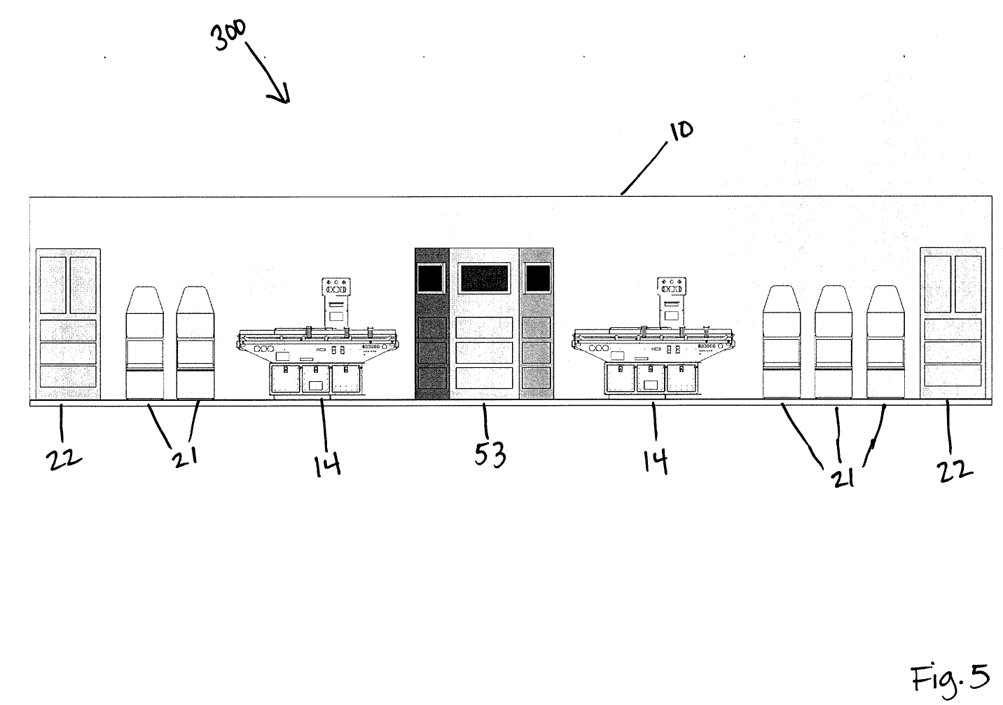

FIGS. 4, 5, 6 illustrate the portable modularized medical unit of the present invention in a critical care embodiment 300. The critical care embodiment 300 comprises a rigid parallelepipedal frame 10 with a base structure, a wall framework comprised of at least four walls, and a roof that all cooperate to serve as a rigid exoskeleton of the portable modularized medical unit. In one embodiment of the unit, the rigid parallelepipedal frame 10 is made of aluminum and is built with dimensions such that it will fit within the known maximum cargo hold dimensions of either a C-17 or C-130 cargo transport aircraft. 13 The critical care embodiment 300 of the present invention has at least one door (not illustrated) disposed within at least one wall of the frame that provides access to the internal portion of the critical care embodiment 300 where medical care and treatment are rendered to patients. The critical care embodiment 300 is designed to accommodate up to five critical care medical beds 14, medical personnel seating 21 for up to nine medical personnel, up to two computer terminal kiosks 52, up to two medical equipment storage cupboards 22, and a storage cabinet 53.

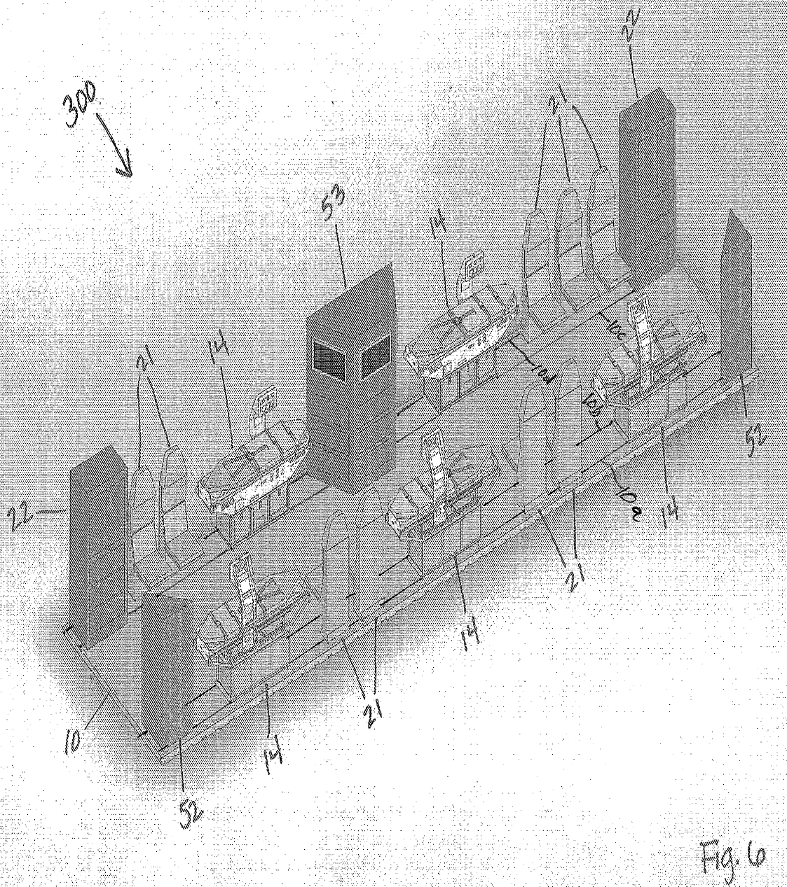

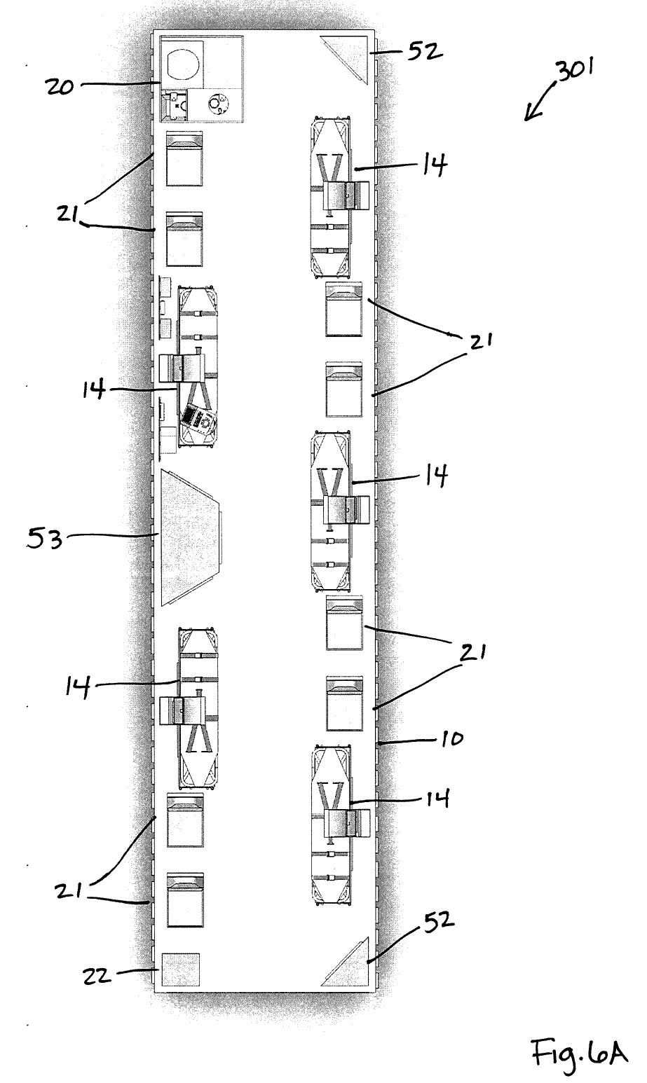

FIG. 6A illustrates the portable modularized medical unit of the present invention in an alternative critical care embodiment 301. The alternative critical care embodiment 301 comprises a rigid parallelepipedal frame 10 with a base structure, a wall framework comprised of at least four walls, and a roof that all cooperate to serve as a rigid exoskeleton of the portable modularized medical unit. In one embodiment of the unit, the rigid parallelepipedal frame 10 is made of aluminum and is built with dimensions such that it will fit within the known maximum cargo hold dimensions of either a C-17 or C-130 cargo transport aircraft. The alternative critical care embodiment 301 of the present invention has at least one door (not illustrated) disposed within at least one wall of the frame that provides access to the internal portion of the alternative critical care embodiment 301 where medical care and treatment are rendered to patients. The alternative critical care embodiment 301 is designed to accommodate up to five critical care medical beds 14, medical personnel seating 21 for up to eight medical personnel, up to two computer terminal kiosks 52, and a lavatory with sink 20, one medical equipment storage cupboard 22, and a storage cabinet 53.

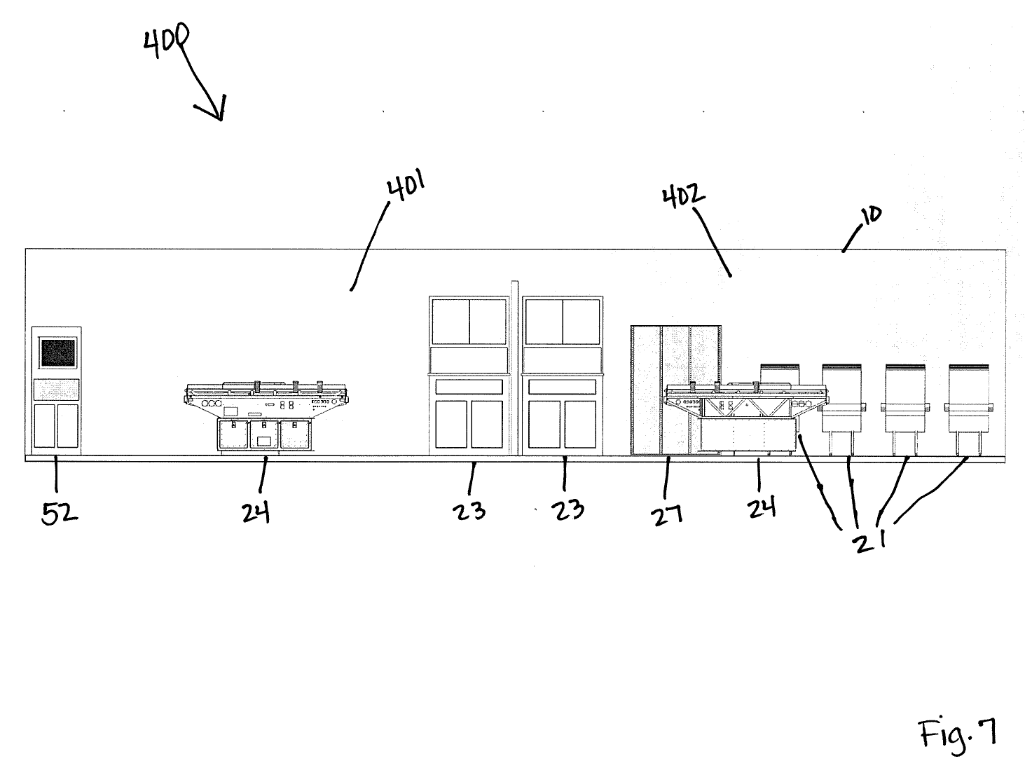

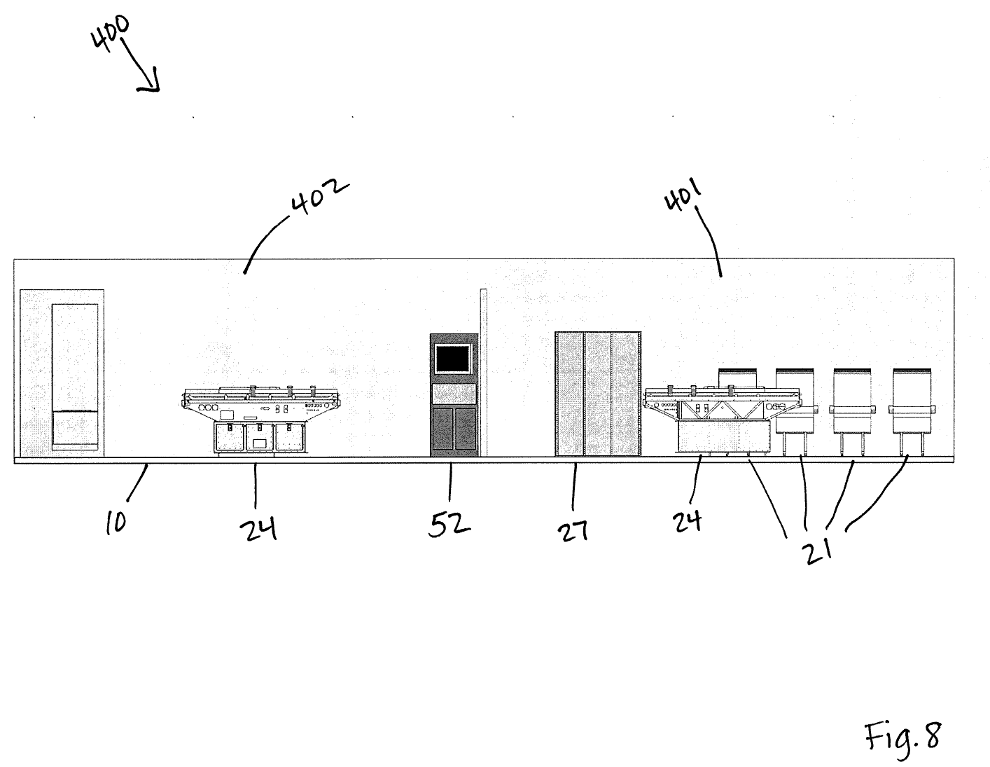

FIGS. 7, 8, 9 illustrate the portable modularized medical unit of the present invention in a critical care isolation ward embodiment 400. The critical care isolation ward embodiment 400 comprises a rigid parallelepipedal frame 10 with a base structure, a wall framework comprised of at least four walls, and a roof that all cooperate to serve as a rigid exoskeleton of the portable modularized 14 medical unit. In one embodiment of the unit, the rigid parallelepipedal frame 10 is made of aluminum and is built with dimensions such that it will fit within the known maximum cargo hold dimensions of either a C-17 or C-130 cargo transport aircraft. The critical care isolation ward embodiment 400 of the present invention has at least one door (not illustrated) disposed within at least one wall of the frame 10 that provides access to the internal portion of the critical care isolation ward embodiment 400 where medical care and treatment are rendered to patients. The critical care isolation ward embodiment 400 is separated in the middle by a closable partition wall 40 that can be closed in order to isolate a first isolation compartment 401 from a second isolation compartment 402. The first isolation compartment 401 and the second isolation compartment 402 each contain a critical care medical bed 24, seating for up to four medical personnel 21, a computer terminal kiosk 52, a medical equipment storage closet 27, and a combination sink and medical storage compartment 23.

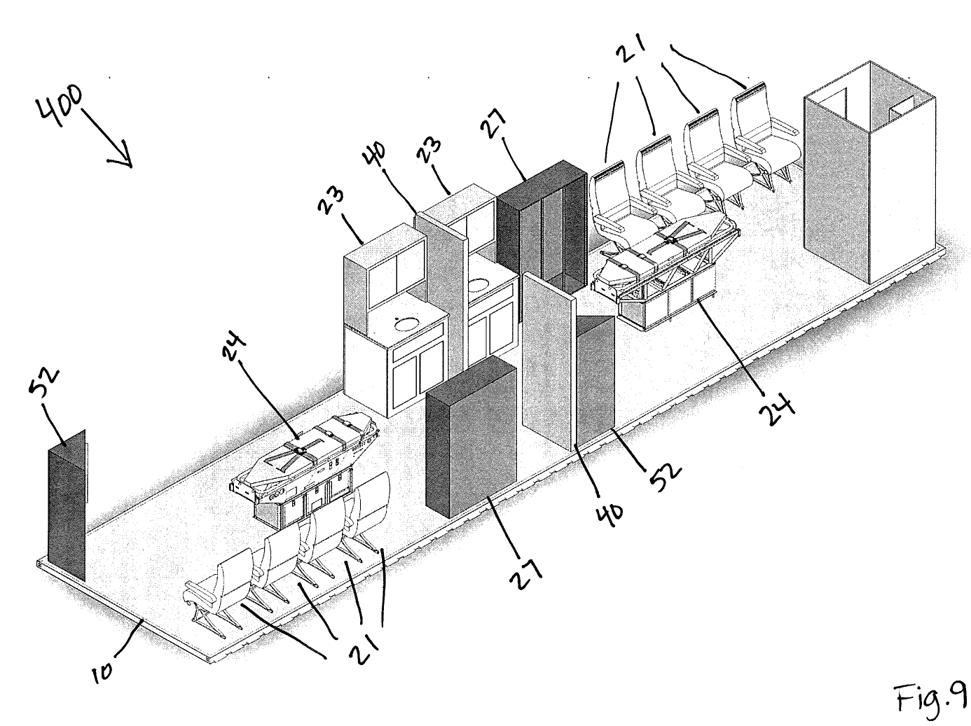

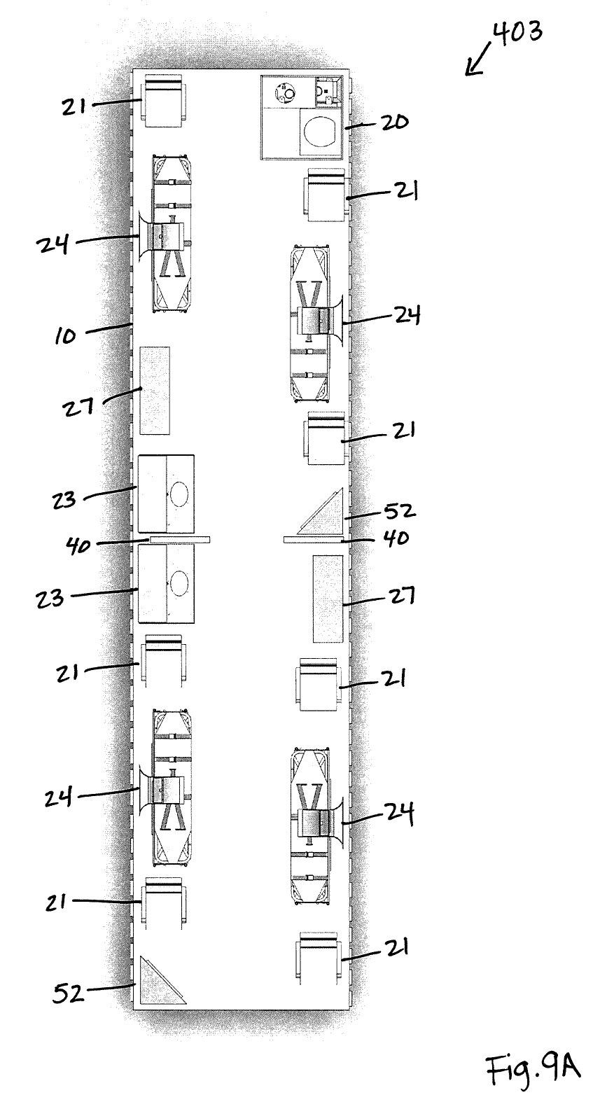

FIG. 9A illustrates the portable modularized medical unit of the present invention in an alternative critical care isolation ward embodiment 403. The alternative critical care isolation ward embodiment 401 comprises a rigid parallelepipedal frame 10 with a base structure, a wall framework comprised of at least four walls, and a roof that all cooperate to serve as a rigid exoskeleton of the portable modularized medical unit. In one embodiment of the unit, the rigid parallelepipedal frame 10 is made of aluminum and is built with dimensions such that it will fit within the known maximum cargo hold dimensions of either a C-17 or C-130 cargo transport aircraft. The alternative critical care isolation ward embodiment 403 of the present invention has at least one door (not illustrated) disposed within at least one wall of the frame 10 that provides access to the internal portion of the alternative critical care isolation ward embodiment 403 where medical care and treatment are rendered to patients. The alternative critical care isolation ward embodiment 403 is separated in the middle by a closable partition wall 40 that can be closed in order to isolate a first isolation compartment 404 from a second isolation compartment 405. The first isolation compartment 404 and the second isolation compartment 405 each contain two critical care medical beds 24, seating for at least three medical personnel 21, a computer terminal kiosk 52, a medical equipment storage closet 27, and a combination sink and medical storage compartment 23. The first isolation compartment 404 also contains a lavatory and sink 20.

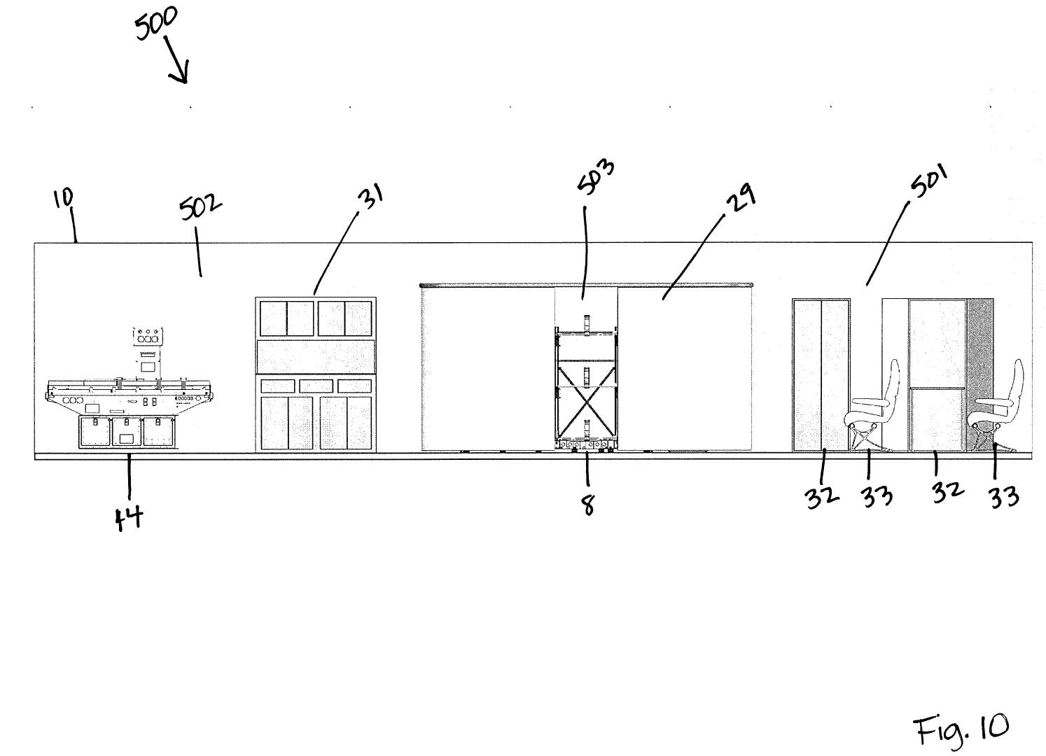

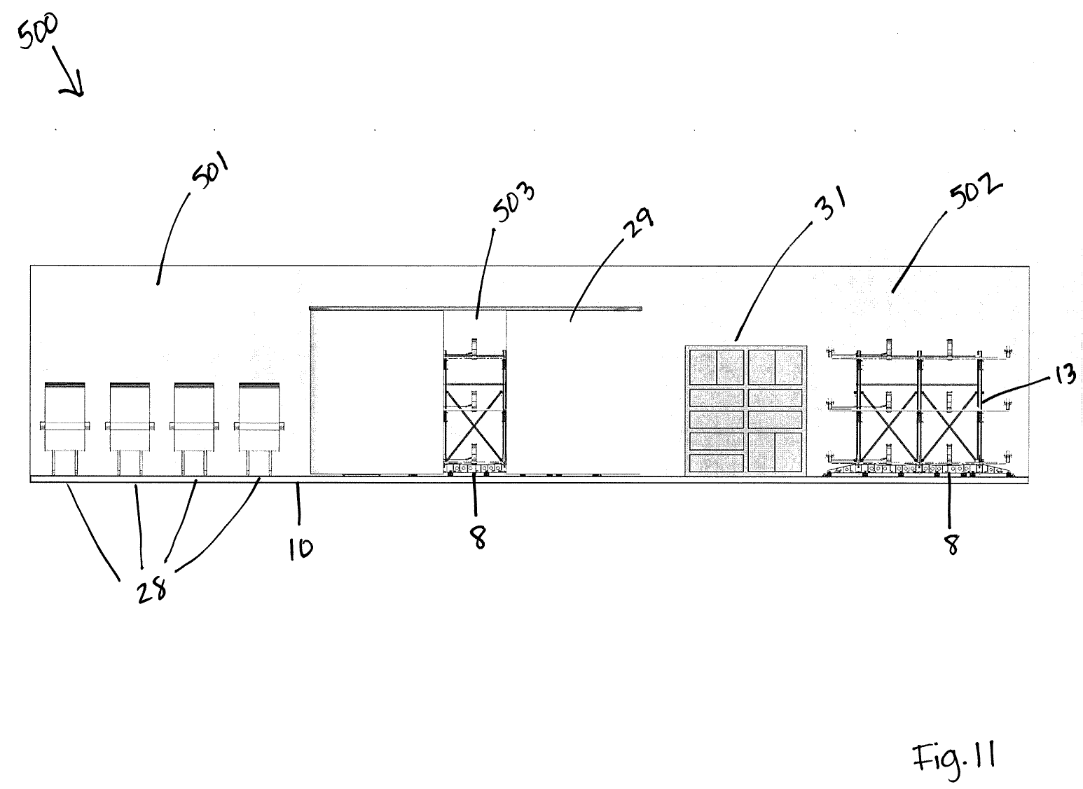

FIGS. 10, 11, 12 illustrate the portable modularized medical unit of the present invention in an exam treatment embodiment 500. The exam treatment embodiment 500 comprises a rigid parallelepipedal frame 10 with a base structure, a wall framework comprised of at least four walls, and a roof that all cooperate to serve as a rigid exoskeleton of the portable modularized medical unit. In one embodiment of the unit, the rigid parallelepipedal frame 10 is made of aluminum and is built with dimensions such that it will fit within the known maximum cargo hold dimensions of either a C-17 or C-130 cargo transport aircraft. The exam treatment embodiment 500 of the present invention has at least one door (not illustrated) disposed within at least one wall of the frame 10 that provides access to the internal portion of the exam treatment embodiment 500 where medical care and treatment are rendered to patients. The exam treatment embodiment 500 has a waiting room area 501 located at one end, an examination room 502 at the opposite end, and a private patient waiting area 503 in the middle that is disposed between the waiting room area 501 and the examination room 502. The waiting room area 501 contains desk chairs 33 for medical personnel to use, wall-mounted desks 32 that can be used by medical personnel while performing initial triage or interviewing patients in the waiting room area 501, and waiting room area seating 28 for patients who are waiting to be triaged or waiting to be treated. At the opposite end of the exam treatment embodiment 500, the examination room 502 contains a critical care medical bed 14, a stretcher support rack 8 supporting three medical litter stretchers 13, and one or more work benches with medical equipment storage 31. The private patient waiting area 503 contains two curtain partitions 29 that are located on the left side and the right side of the patient waiting area 503. Each of the curtain partitions 29 partially encloses an area in which there is located a stretcher support rack 8 supporting three medical litter stretchers 13 and medical personnel 16 seating 21. A central corridor is disposed along the longitudinal center of the exam treatment embodiment 500 between the two curtain partitions 29 such that it is possible to walk from the waiting room 501 through the private patient waiting area 503 and into the examination room 502.

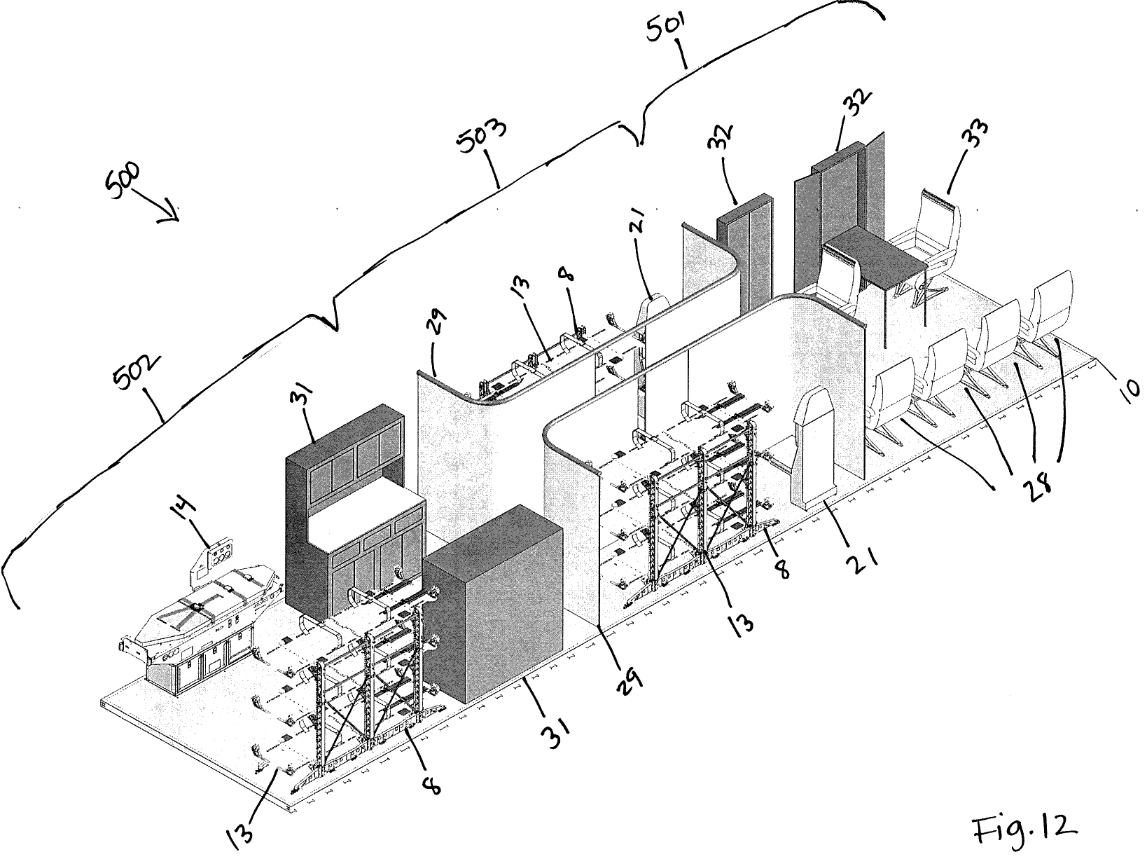

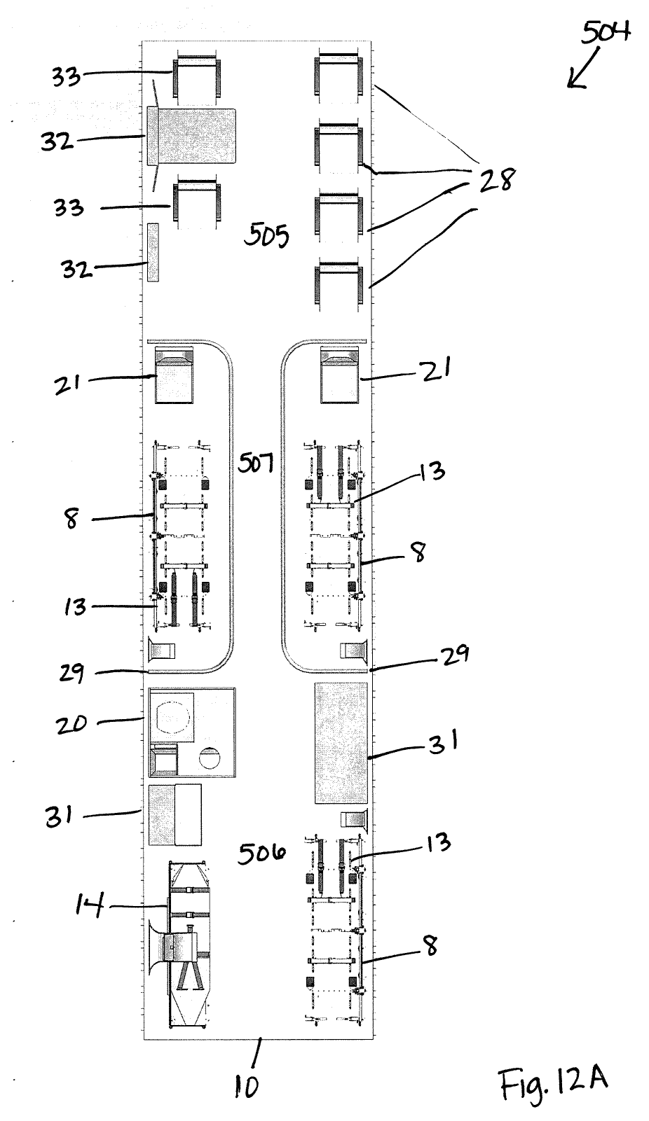

FIG. 12A illustrates the portable modularized medical unit of the present invention in an alternative exam treatment embodiment 504. The alternative exam treatment embodiment 504 comprises a rigid parallelepipedal frame 10 with a base structure, a wall framework comprised of at least four walls, and a roof that all cooperate to serve as a rigid exoskeleton of the portable modularized medical unit. In one embodiment of the unit, the rigid parallelepipedal frame 10 is made of aluminum and is built with dimensions such that it will fit within the known maximum cargo hold dimensions of either a C-17 or C-130 cargo transport aircraft. The alternative exam treatment embodiment 504 of the present invention has at least one door (not illustrated) disposed within at least one wall of the frame 10 that provides access to the internal portion of the alternative exam treatment embodiment 504 where medical care and treatment are rendered to patients. The exam treatment embodiment 504 has a waiting room area 505 located at one end, an examination room 506 at the opposite end, and a private patient waiting area 507 in the middle that is disposed between the waiting room area 505 and the examination room 506. The waiting room area 505 contains desk chairs 33 for medical personnel to use, wall-mounted desks 32 that can be used by medical personnel while performing initial triage or interviewing patients in the waiting room area 505, and waiting room area seating 28 for patients who are waiting to be triaged or waiting to be treated. At the opposite end of the alternative exam treatment embodiment 504, the examination room 506 contains a critical care medical bed 14, a stretcher support rack 8 supporting three medical litter stretchers 13, a lavatory with sink 20, and one or more work benches with medical equipment storage 31. The private patient waiting area 507 contains two curtain partitions 29 that are located on the left side and the right side of the patient waiting area 507. Each of the curtain partitions 29 partially encloses an area in which there is located a stretcher 17 support rack 8 supporting three medical litter stretchers 13 and medical personnel seating 21. A central corridor is disposed along the longitudinal center of the alternative exam treatment embodiment 504 between the two curtain partitions 29 such that it is possible to walk from the waiting room 505 through the private patient waiting area 507 and into the examination room 506.

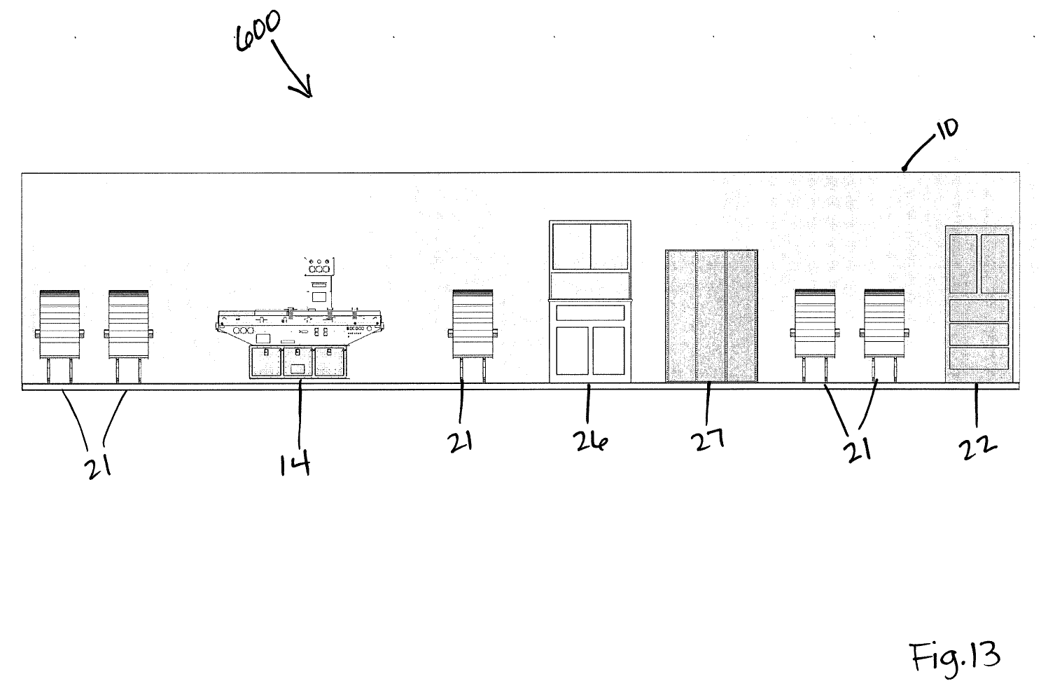

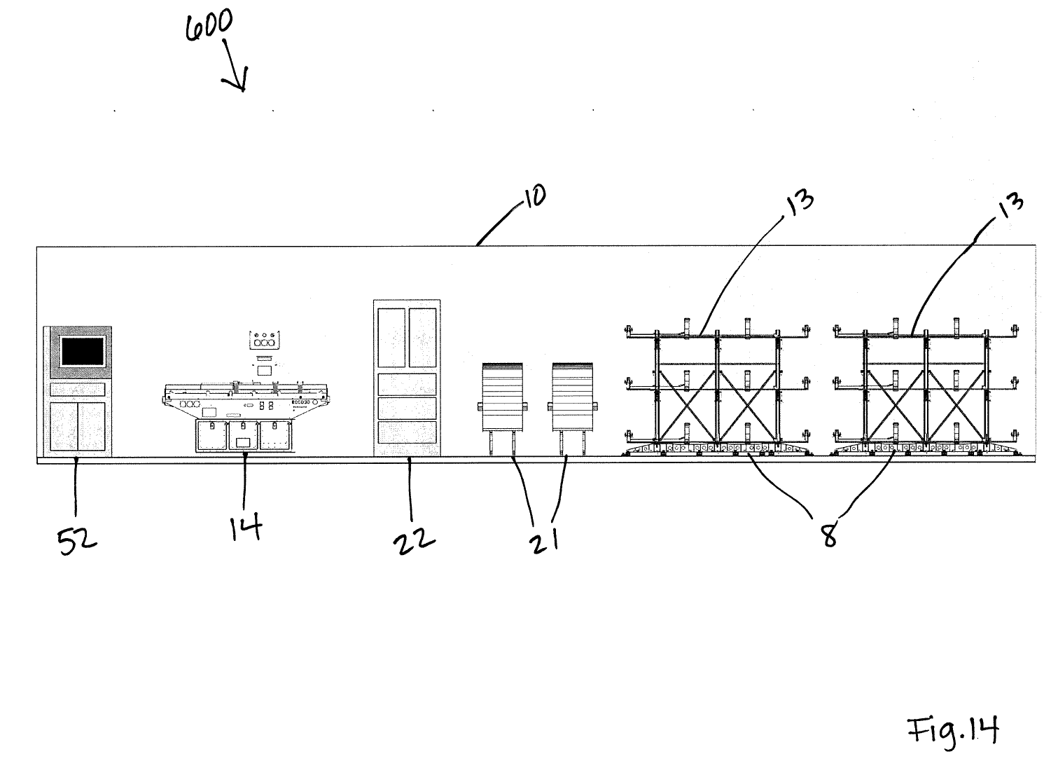

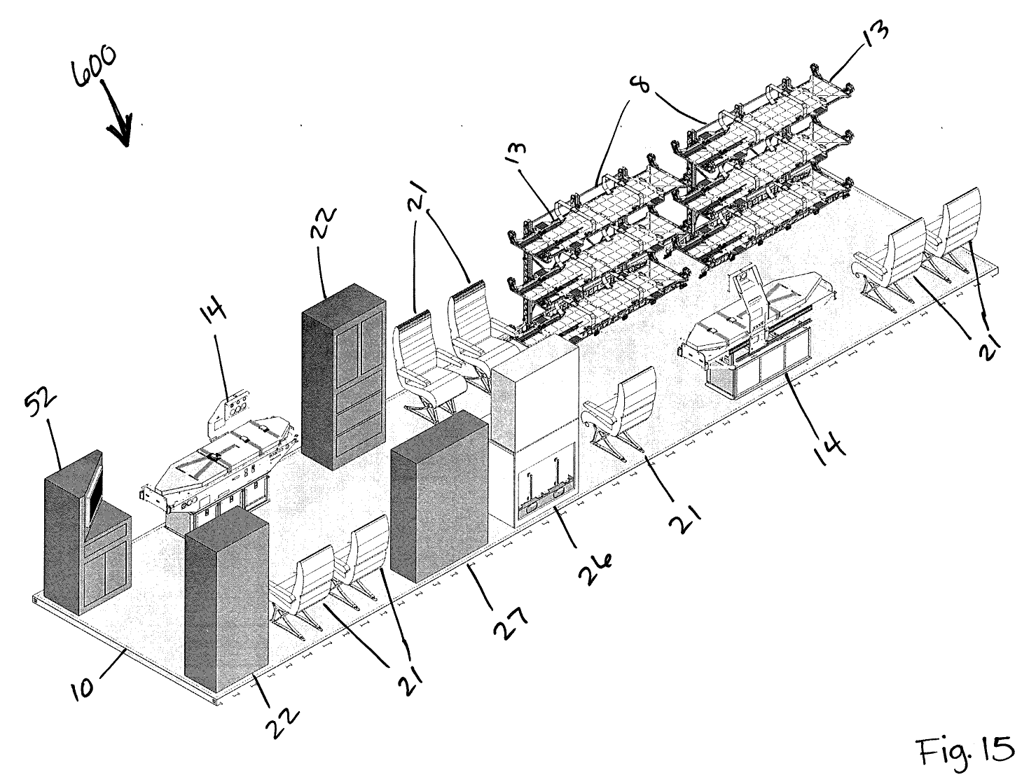

FIGS. 13, 14, 15 illustrate the portable modularized medical unit of the present invention in a mixed mass casualty/critical care embodiment 600. The mixed mass casualty/critical care embodiment 600 comprises a rigid parallelepipedal frame 10 with a base structure, a wall framework comprised of at least four walls, and a roof that all cooperate to serve as a rigid exoskeleton of the portable modularized medical unit. In one embodiment of the unit, the rigid parallelepipedal frame 10 is made of aluminum and is built with dimensions such that it will fit within the known maximum cargo hold dimensions of either a C-17 or C-130 cargo transport aircraft. The mixed mass casualty/critical care embodiment 600 of the present invention has at least one door (not illustrated) disposed within at least one wall of the frame 10 that provides access to the internal portion of the mixed mass casualty/critical care embodiment 600 where medical care and treatment are rendered to patients. The mixed mass casualty/critical care embodiment 600 contains up to two critical care medical beds 14, medical personnel seating for up to seven medical personnel 21, one computer terminal kiosks 52, up to two medical litter support racks 8 upon each of which are mounted three medical litter stretchers 13, at least one medical equipment storage cupboard 22, a medical equipment storage closet 27, and a medical equipment shelving unit 26.

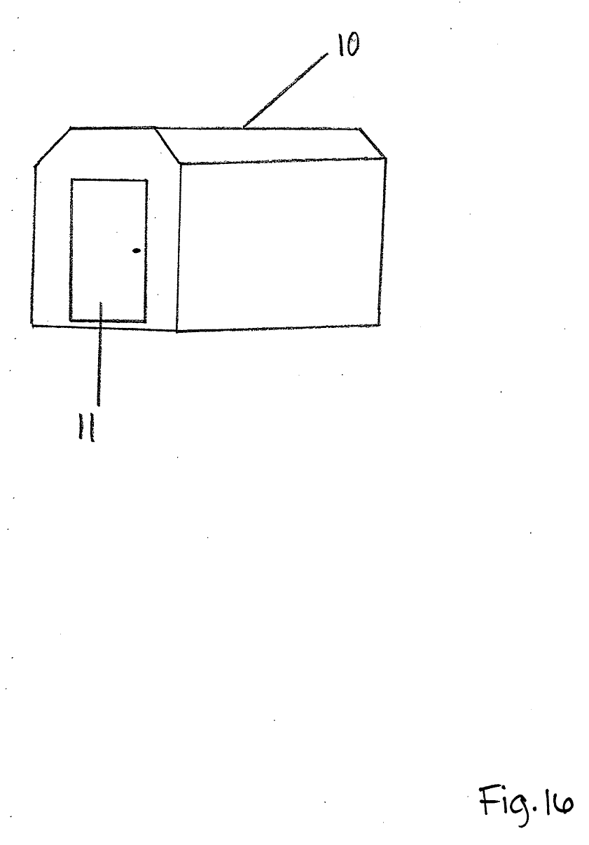

FIG. 16 illustrates the fact that the portable modularized medical units of the present invention are each constructed with a rigid parallelepipedal frame 10 comprised of a base structure, a wall framework with at least four walls, and a roof, all of which are rigidly joined together and cooperate to serve as the rigid exoskeletons for each of the portable modularized medical units. The various 18 components that may be placed into, or removed from, the internal portions of the portable modularized medical units in order to place the units into varying embodiments will be attached in an airworthy but removable manner to the base structure, walls, or roof of the rigid parallelepipedal frame. The portable modularized medical units will each have at least one door 11 disposed within the at least one of the walls comprising the wall framework of the rigid parallelepipedal frame 10. It is important to understand that the components in the internal portion of a unit will be removably attached to one or more elements that comprise the rigid parallelepipedal frame 10. In one embodiment, the rigid parallelepipedal frame 10 is comprised of an aluminum base structure, wall framework with at least four aluminum walls, and an aluminum roof, with the limitation that the external dimensions of the rigid parallelepipedal frame are limited in each direction to the known maximum cargo hold dimensions of either a C-17 or C-130 cargo transport aircraft. In this embodiment of the portable modularized medical unit, the internal top surface of the base structure of the rigid parallelepipedal frame 10 will be rigidly connected to at least one, and not more than eight, longitudinal metal tracks 10a, 10b, 10c and 10d that run along the length of the top surface of the base structure and provide multiple anchor points for removable, airworthy connection of the components located in the internal portion of the unit to the rigid parallelepipedal frame of the unit. The term airworthy is defined by the Federal Aviation Administration, Department of Transportation, FAA (FAR Part 21.183(a), (b), and (c) which is codified at 14 CFR 21.183 and 14 CFR 21.130. The connection between these longitudinal metal tracks 10a, 10b, 10c and 10d and the components will be made in the same or similar manner as the connection between passenger seating and longitudinal seat tracks that are used in commercial aviation which is well known in the art. An entry and exit door may be disposed within one or both distal ends of the rigid parallelepipedal frame 10, such as the door 11 that is shown as being disposed within a distal wall of the rigid frame 10 as illustrated in FIG. 16. While the embodiment discussed immediately above involves a rigid parallelepipedal frame 10 made of aluminum structural elements, it should be appreciated that any generally parallelepipedal rigid metal or composite structure capable of being loaded into or onto and out 19 of or off of a cargo transport vehicle may be used as the rigid frame 10 of the portable modularized medical units without departing from the scope of this invention.

It is to be understood that each of the embodiments and alternative embodiments disclosed in FIGS. 1-15 are each an embodiment of the portable modularized medical unit disclosed by this application, including the medical evacuation embodiment 100, mass casualty embodiment 200, alternative mass casualty embodiment 201, critical care embodiment 300, alternative critical care embodiment 301, critical care isolation ward embodiment 400, alternative critical care isolation ward embodiment 403, exam treatment embodiment 500, alternative exam treatment embodiment 504, and mixed mass casualty/critical care embodiment 600. These embodiments and alternative embodiments are illustrative of different ways in which the portable modularized medical unit taught by this provisional application may give different internal arrangements or configurations of components within the internal portion of each unit such that the capabilities for provision of medical care and treatment or medical evacuation will vary from unit to unit based on the embodiment of the unit that is loaded onto (or into) a cargo transport vehicle for transport to and from a remote location or devastated area. It is also possible to rearrange the components in the internal portion of any single portable modularized medical unit based on the preference or choice of the end user such that the capabilities for provision of medical care and treatment or medical evacuation at a remote location or devastated area can be more narrowly tailored to the perceived medical or evacuation needs of the patients in such location or area. The removal and replacement of a component in the internal portion of a portable modularized medical unit is possible by detaching any given undesired component from its connection points on the internal longitudinal metal tracks 10a, 10b, 10c and 10d running along the length of the top surface of the base structure and then attaching a desired component via connection points to the longitudinal metal tracks 10a, 10b, 10c and 10d. In this manner, all of the components internal to the units may be attached, removed, relocated, replaced, and rearranged inside of the portable modularized medical units.

It is to be understood that FIGS. 1-16 are not drawn to scale and are merely meant to illustrate the fact that the scope of the invention disclosed encompasses multiple possible internal arrangements and rearrangements of various internal components used in the provision of medical care and medical evacuation, including various arrangements and rearrangements of items such as medical equipment storage, medical personnel seating, medical litter stretchers, medical litter support racks, critical care medical beds, sinks, cabinets, computer terminal kiosks, desks, chairs, and the like.

Although illustrative embodiments have been described hereinabove with reference to the accompanying drawings, it should also be understood that the present invention is not limited to those precise embodiments, and that various changes and modifications may be made to the number and internal arrangement of the components in the internal portion of the embodiments depicted without departing from the scope or spirit of the invention. All such changes and modifications are intended to be included within the scope of the invention.

### SUMMARY OF THE INVENTION

The portable modularized medical units and the system of using said units disclosed by this application allows for the units to be loaded into, and offloaded from, cargo transport vehicles on an as needed basis. The containerized nature of the portable modularized medical units makes them transportable by cargo transport vehicles, including aircraft, trucks, trains, and ships. The loading of a portable modularized medical unit into (or onto) such a cargo transport vehicle effectively turns the cargo transport vehicle into a mobile medical facility or mobile ambulance that can be moved to the location or area where medical care and treatment or medical evacuation is needed such that the requisite medical care and treatment or medical evacuation may be rapidly provided to patients at that site or during transport from that site. The containerized nature of the portable modularized medical units allows for them to be offloaded or removed from the cargo transport vehicles when the portable 21 modularized medical units are not in use so that the cargo transport vehicles can be repurposed and are not permanently dedicated to the provision of medical care and treatment or medical evacuation on a static basis. The portable modularized medical units disclosed in this invention have the characteristic that they are interchangeable with each other such that a single unit with a particular internal arrangement of components may be offloaded rapidly and another unit having a different internal arrangement of components or wholly different components may be substituted in place of the first unit inside or on the cargo transport vehicle. The portable modularized medical units are further modularized in the sense that the components within the units, while attached to the frame of the units in an airworthy manner, are nevertheless removably attached to the frame and therefore may be removed and replaced, or rearranged, in order to convert any given unit from one embodiment of the portable modularized medical unit to another embodiment of the portable modularized medical unit, depending only upon the choice of the end user of the unit and the perceived need for type of medical care and treatment or medical evacuation required at the location or area where the portable modularized medical unit is to be transported in the cargo transport vehicle. In certain embodiments, the components may be removably attached to the rigid frame of the units using multiple longitudinal metal tracks 10a, 10b, 10c and 10d to which the components are attached in an airworthy but removable manner. The components may also be connected to, or tethered to, the wall framework and/or roof of a unit, but these connections or tethering will also be removable such that each component can be removed from, or rearranged inside, each unit.

The portable modularized medical unit is constructed with a rigid parallelepipedal frame that serves as a rigid exoskeleton of the portable modularized medical unit. The rigid parallelepipedal frame of the portable modularized medical unit is comprised of generally planar members including a base structure, a wall framework with at least four walls, and a roof, all of which are rigidly connected and cooperate to serve as a rigid exoskeleton for the unit. The parallelepipedal rigid frame of each unit will 22 have at least one door disposed within one of its walls to allow ingress into, and egress out of, the internal portion of the portable modularized medical unit by medical personnel and patients. Additional doors may be disposed in the walls of the wall framework of a unit such that any of the walls could have a door disposed within the wall so long as at least one wall has at least one door. In some instances there may be a double door disposed within a wall of the wall framework allowing for easier litter access to the internal portion of the portable modularized medical unit.

In one embodiment, the portable modularized medical unit's rigid parallelepipedal frame that serves as the rigid exoskeleton of the unit is a rigid aluminum parallelepipedal frame comprised of a base structure, a wall framework comprised of at least four walls, at least one door disposed within one of the walls, and a roof. The base structure of this embodiment is comprised of aluminum structural members that support, and are mechanically fastened to, but not welded to, an upper surface of the base structure that is a planar aluminum floor panel, with the top of such upper surface serving as the floor of the internal portion of the unit and being rigidly connected to at least one, but not more than eight, longitudinal metal tracks that each provide multiple connection/attachment points for airworthy but removable attachment of the components that are located within the internal portion of the portable modularized medical unit. The aluminum structural members of the base structure of this embodiment will provide fore and aft rolling surfaces for the cargo handling system rollers that are found within the cargo hold of the cargo transport aircraft used by the end-user to transport the unit. The wall framework of this embodiment is comprised of at least four walls that are mechanically fastened, but not welded, to the base structure of the unit, with the wall framework being further comprised of at least one door, all of which wall framework is comprised of aluminum tubing, aluminum extrusions, and aluminum sheet metal, and all of which elements are mechanically fastened together with no welding. The roof structure of this embodiment is comprised of a generally planar aluminum roof panel that is mechanically fastened to the top of the wall framework, again with no welding 23 involved. Aircraft quality, sound resistant dampening and insulation material that reduces external noise outside of the unit during transport to an internal acoustical level of 65-75 decibels or less than 75 decibels will be disposed within voids of the base structure between the aluminum structural members and the upper surface, and will also be disposed between and within the tubular structural members of the wall framework and each door of this embodiment. In this embodiment of the unit, the underside of the base structure of the rigid aluminum parallelepipedal frame will be further attached to a locking that is designed to lock into place utilizing the aircraft cargo handling system that is provided within the cargo hold of the cargo transport aircraft that is to be used by the end user to transport the portable modularized medical unit. The lock on the underside is a standard airworthy lock that is secured to a mating airworthy lock on aircraft cargo handling system of the aircraft.

In an embodiment of the portable modularized medical unit, the unit's rigid aluminum parallelepipedal structure has external dimensions of 471 inches length, 105.5 inches height, and 100 inches width.

In another embodiment of the portable modularized medical unit, the unit's rigid aluminum parallelepipedal structure has external dimensions of 285 inches length, 105.5 inches width, and 100 inches height.

In an embodiment of the portable modularized medical unit disclosed herein, the unit shall also contain electrical power converters that may be connected via one or more ports disposed within a wall of the rigid parallelepipedal frame to the electrical power supply of a cargo transport aircraft when the unit is loaded into the cargo hold of the cargo transport aircraft. These power converters will allow for electronic devices placed inside the portable modularized medical unit to be powered by 400 Cycle/28 Volt electrical power that is provided by the cargo transport aircraft. When this embodiment of the portable modularized medical unit is not loaded into the cargo hold of a cargo transport aircraft, the power converters may be connected to ground-based 110-120 Volt/60 Cycle power or to ground-based 220-250 Volt/50 Cycle power which will allow electronic devices placed inside the portable modularized medical unit to be powered using ground-based electrical power supply. The power converters will allow for electronic devices located inside the units to be powered using 115 VAC, 3 phase, 400 Hz and 28 VDC power supplies. Standard climate control equipment is mounted on or in the unit to maintain comfortable climate control of the interior of the unit.

In an embodiment of the portable modularized medical unit disclosed herein, the unit's dry weight without any patients, medical personnel, medical equipment, fluids, or containerized compressed gasses such as oxygen being present in the internal portion of the unit, shall not exceed 16,000 pounds.

The system for using the portable modularized medical units of this invention provides for each of the individual portable modularized medical units employed by a particular end user to be interchangeable with one another. To achieve this interchangeability between portable modularized medical units as envisioned by the system of using the units, the rigid parallelepipedal frames of each of the units used by a particular end user shall have the same external dimensions within a certain limited tolerance of up to one foot or less in any direction. Thus, the individual portable modularized medical units used by an end user are interchangeable with each other and one unit may be removed from a cargo transport vehicle and rapidly replaced by another unit that is loaded into the same cargo transport vehicle with no restructuring of internal height, length and width dimensions of the cargo hold or cargo transport platform of the cargo transport vehicle because the units have the same external dimensions.

The enhanced utility of a system in which portable modularized medical units are interchangeable, one with another, comes from the ability to rapidly change the medical treatment and medical evacuation capabilities of the loaded cargo transport vehicle by changing the embodiment that is loaded into (or onto) the cargo transport vehicle. The end user may have a need to rapidly exchange one embodiment of the portable modularized medical unit having a particular internal configuration of components for another embodiment of the portable modularized medical unit having a different 25 internal configuration of components in order to address fluctuating medical needs at a remote location or devastated area, or to respond to a new situation existing in a different location. For example, the end user may have an initial need to perform critical care operations and evacuation from a remote location for patients who are severely injured. The same end user may shortly thereafter have a need to perform mass casualty evacuation of multiple patients who are less severely injured from the same remote location or from a wholly different location. In such a hypothetical situation, the end user could initially place a portable modularized medical unit in a critical care embodiment (such as that shown in FIGS. 4-6) into the cargo transport vehicle and use it for a first mission, and then, after the first critical care mission is completed, the end user could rapidly remove that whole unit from the cargo transport vehicle and replace it with a second unit having a mass casualty embodiment (such as that shown in FIGS. 2-3) for completion of a second mission involving mass casualty medical care or evacuation. The consistency of the external dimensions of the parallelepipedal frames of each portable modularized medical unit employed by an end user makes the units interchangeable and gives the end user great flexibility in addressing fluctuating medical care and evacuation needs.

The interchangeability of the portable modularized medical units gives them great utility for the end user when faced with alterations in the type of medical care needed on the ground at the remote location or devastated area because one unit can be rapidly offloaded from the cargo transport vehicle and replaced with another unit that is substituted into or onto the cargo transport vehicle, thereby changing the mission capabilities of the cargo transport vehicle based on what embodiment of the portable modularized medical unit is loaded into the vehicle. In the system disclosed hereby, any embodiment of the portable modularized medical unit that is loaded into or onto a cargo transport vehicle by a particular end-user may be removed from the cargo transport vehicle and then a separate unit with the same external dimensions (within a tolerance of one foot in any direction) but a different 26 arrangement of internal components may be substituted in its place without changing the dimensions of the cargo hold or cargo transport platform of the cargo transport vehicle.

It should be appreciated that the interchangeable nature of the portable modularized medical units may be maintained even where there are some small variations in the external dimensions of the units. For instance, by way of example only, a portable modularized medical unit having a length of 285 inches and height of 100 inches could be replaced by a separate unit having a length of 287 inches and height of 98 inches. In such a case, the slight variance in the external dimensions of the units would have no appreciable effect on the interchangeable nature of the units. So long as the external dimensions of the portable modularized medical units are such that they are interchangeable with each other and no resizing of the cargo hold or cargo transport platform of the cargo transport vehicle is necessary when substituting one unit for another unit, each of the portable modularized medical units would come within the scope of this invention despite having some slight variance in their external dimensions. Furthermore, while the exact external dimensions of the portable modularized medical units may vary somewhat from unit to unit, the external dimensions of the units will be limited on the high-end in a practical manner by the known maximum cargo hold dimensions, i.e., maximum cargo capacity, of the cargo transport vehicle that is to be employed by the end-user to transport the units. For instance, in an embodiment the portable modularized medical units of this invention will be capable of being transported within the cargo hold of either a C-17 or a C-130 transport aircraft. Since the known maximum cargo hold dimensions of the C-130 aircraft for purposes of this application are forty feet (40′) length, nine feet ten inches (9′10″) width, and nine feet (9′) height, the portable modularized medical units in embodiments of this invention used in C-130 aircraft are limited to those known maximum cargo hold dimensions of the C-130 aircraft. In another embodiment of the portable modularized medical units, the units may be transported within the cargo hold of a C-17 transport aircraft, and therefore since the known maximum cargo hold dimensions of the C-17 aircraft for the 27 purposes of this application are 88 feet (88′) length, eighteen feet (18′) width, and twelve feet (12′) height, the dimensions of the units in embodiments of this invention to be used in C-17 aircraft are limited to the maximum known dimensions of the cargo hold of the C-17 aircraft.

Another aspect of the modular nature of the portable modularized medical units disclosed herein is that the type, number and arrangement of the components inside the internal portions of the units not only may vary from one embodiment to another embodiment, but the type, number, and arrangement of the components in the internal portion of each individual unit can be altered or changed by removal and replacement of individual components because all of the components are removably attached to one or more internal surfaces of the rigid parallelepipedal frame that serves as the rigid exoskeleton of the portable modularized medical units. Components such as critical care medical beds, medical personnel seating, computer terminal kiosks, medical litter support racks, medical litter stretchers, medical equipment storage cupboards, medical equipment storage closets, medical equipment shelving, desks, chairs, sinks, lavatories, partitions, and radiological diagnostic equipment are all attached in an airworthy but removable manner to one or more internal surfaces of the rigid parallelepipedal frame of the portable modularized medical units. While each of these components when placed within an embodiment will be mounted in a sturdy, airworthy manner to one or more internal surfaces of the unit's frame, all such components will be mounted in a removable fashion. In an embodiment discussed earlier in this application, the removable attachment between components and the rigid parallelepipedal frame is accomplished using longitudinal metal tracks 10a, 10b, 10c and 10d that run the length, or at least the majority of the length, of the unit and are rigidly attached to the upper surface of the base structure and provide multiple connection/attachment points for the components to be mounted to the tracks 10a, 10b, 10c and 10d, and thereby interconnected to the rigid frame. As discussed previously, these longitudinal metal tracks 10a, 10b, 10c and 10d will be the same or similar to the seat tracks used to anchor passenger seats in the commercial airline industry, which is well understood in the art. The removable nature of these 28 components inside the internal portion of the portable modularized medical units allows for the components to be removed, replaced with other or different components, or rearranged such that each portable modularized medical unit can be changed from one embodiment to another embodiment by changing the type, the number, or the type and number of the components that are removably attached to the rigid frame inside the internal portion of the unit. The ability to remove, replace, or rearrange the components into a wide variety of varying embodiments of the portable modularized medical units allows for an end user to be less limited with regard to the medical care and treatment that can be provided with the portable modularized medical units that are at the end user's disposal.

The longitudinal metal tracks 10a, 10b, 10c and 10d that provide the attachment or connection points for the components inside the internal portion of the embodiment of the portable modularized medical unit discussed above are rigidly attached to the upper surface of the base structure of the rigid parallelepipedal frame and provide multiple connection/attachment points for the components. These longitudinal metal tracks 10a, 10b, 10c and 10d may run the entire length of the upper surface of the base structure, or they may only run the majority of the length of the base structure without completely extending from distal end to distal end of the unit.

FIGS. 1-15 made part of this application show various embodiments and alternative embodiments of the portable modularized medical unit that vary with regard to their internal arrangement of components such that the internal components' type, number, and arrangement may vary from unit to unit. Many other internal arrangements of the components are possible beyond those disclosed in this application, with the possibility that the end user could create a custom arrangement of components in the internal portion of any individual portable modularized medical unit which better fits its needs because the components are removably attached to the internal surface(s) of the rigid 29 parallelepipedal frame of the unit or to a system of longitudinal metal tracks 10a, 10b, 10c and 10d that provides interconnection between the components and the rigid frame.

As disclosed herein, the system of using the portable modularized medical unit potentially involves the removal, replacement, or rearrangement of components within the internal portion of a single portable modularized medical unit such that the type, number, or arrangement of the components within an individual unit is changed and thereby changes the capabilities for medical care and medical evacuation that are afforded by that individual unit. For example, removal of all of the medical litter stretchers from a portable modularized medical unit in a mass casualty embodiment, and replacement of those medical litter stretchers with critical care medical beds would obviously change the medical care and medical evacuation capabilities of that single unit and make it better suited for provision of critical care or trauma surgery care to patients at remote locations or en route from such remote locations.

The system of using the portable modularized medical units disclosed herein also involves the potential interchangeable use of two or more portable modularized medical units, each of which has a different internal arrangement of components within the internal portion of each such unit. For example, placing a first unit that is in a critical care isolation ward embodiment (see FIGS. 7,8,9) into the cargo hold of a cargo transport vehicle, transporting that unit to a remote location and providing care to patients at that location or en route away from that location, then removing that first unit from the cargo hold of the cargo transport vehicle and placing a second unit that is in an exam treatment embodiment into the cargo hold of the cargo transport vehicle would demonstrate a use of the system disclosed herein. The wholesale replacement of the first unit by the second unit in the cargo transport vehicle changes the medical care and medical evacuation capabilities of the loaded cargo transport 30 vehicle and will typically take far less time than the reconfiguration of the components in the internal portion of a single unit.

Enhanced versatility is achieved by the system of using the portable modularized medical units disclosed in this application in an interchangeable manner when exchanging between two or more units that are already arranged with certain components in a certain set arrangement within the internal portion of the units. Such interchangeability of whole units is envisioned to be relatively rapid such that a first unit in a first embodiment may be removed from the cargo hold or cargo transport platform of a cargo transport vehicle and rapidly replaced by a second unit in a second embodiment that is loaded into (or onto) the cargo hold or cargo transport platform of the cargo transport vehicle.

Enhanced versatility is also realized because the system of using the units involves the use of portable modularized medical units in which the components are attached to the internal surface(s) of the units' rigid frames in a removable and replaceable manner such that each of the critical care medical beds, medical personnel seating, computer terminal kiosks, medical litter support racks, medical litter stretchers, medical equipment storage cupboards, medical equipment storage closets, medical equipment shelving, desks, chairs, sinks, lavatories, wall partitions, curtain partitions, and radiological diagnostic equipment may be attached to or removed from the internal surface(s) of the rigid frame of the units, and therefore may be replaced or rearranged within the internal portion of each single portable modularized medical unit. The removal and replacement or rearrangement of components within an individual portable modularized medical unit placing the individual unit into a new embodiment would likely be somewhat more time consuming than the interchange between two whole units that are already in predetermined embodiments such that one unit is removed from a cargo transport vehicle and replaced by a second unit that is loaded onto or into the cargo transport vehicle. The probable variance in time between an interchange of two units and a rearrangement or change to 31 the type or number of components in the internal portion of a single unit would be due to the fact that the components within each single unit must be attached in a sturdy, airworthy manner to one or more internal surfaces of the unit's frame and such sturdy, airworthy attachment will mean that detachment of the components from the frame and removal or rearrangement of the components will not be instantaneous. The total time for replacing or rearranging the components in a single unit can be decreased through the use of longitudinal metal tracks with multiple connection/attachment points that run along the length of the floor of the internal portion of the unit as disclosed hereinabove.

Enhanced versatility is also realized because the system of using the units involves the use of portable modularized medical units in which the components are attached to the internal surface(s) of the units' rigid frames in a removable and replaceable manner such that each of the critical care medical beds, medical personnel seating, computer terminal kiosks, medical litter support racks, medical litter stretchers, medical equipment storage cupboards, medical equipment storage closets, medical equipment shelving, desks, chairs, sinks, lavatories, wall partitions, curtain partitions, and radiological diagnostic equipment may be attached to or removed from the internal surface(s) of the rigid frame of the units, and therefore may be replaced or rearranged within the internal portion of each single portable modularized medical unit. The removal and replacement or rearrangement of components within an individual portable modularized medical unit placing the individual unit into a new embodiment would likely be somewhat more time consuming than the interchange between two whole units that are already in predetermined embodiments such that one unit is removed from a cargo transport vehicle and replaced by a second unit that is loaded onto or into the cargo transport vehicle. The probable variance in time between an interchange of two units and a rearrangement or change to 31 the type or number of components in the internal portion of a single unit would be due to the fact that the components within each single unit must be attached in a sturdy, airworthy manner to one or more internal surfaces of the unit's frame and such sturdy, airworthy attachment will mean that detachment of the components from the frame and removal or rearrangement of the components will not be instantaneous. The total time for replacing or rearranging the components in a single unit can be decreased through the use of longitudinal metal tracks 10a, 10b, 10c and 10d with multiple connection/attachment points that run along the length of the floor of the internal portion of the unit as disclosed hereinabove.

1. A portable airworthy modularized medical unit that can be transported by airplane, helicopter, truck, rail, or ship to and from any location where emergency medical care, trauma care, surgical care, intensive care, isolation care, critical care, mass casualty, exam treatment or emergency medical evacuation are needed, comprising:
a rigid parallelepipedal airworthy frame that serves as the rigid exoskeleton of the unit that is a rigid aluminum parallelepipedal frame comprised of a base structure having an inner base structure, a wall framework comprised of at least four walls, at least one door disposed within one of the walls and a roof;
a plurality of longitudinal airworthy metal tracks that provide for attaching or connecting the various medical components inside the internal portion of the portable modularized medical unit and which tracks are rigidly attached to the interior surface of the base structure of the rigid parallelepipedal frame to provide multiple connection and attachment points for the components in an airworthy but removable manner to the base structure, walls, or roof of the rigid parallelepipedal frame so that the components internal to the unit may be attached, removed, relocated, replaced, and rearranged inside of the portable modularized medical unit
the airworthy tracks securing any combination of removable components including medical equipment, a chair, closable partition wall, computer terminal kiosk, critical care medical beds, curtain partitions, desk chairs, lab table which contains internal storage space for medical equipment, lavatory with sink, medical equipment shelving unit, medical equipment storage closet, medical equipment storage cupboards, medical litter stretchers, medical litter support racks, medical personnel seating, radiological medical diagnostic equipment, diagnostic equipment, monitoring equipment, storage cabinet, wall mounted desks or work benches with medical equipment storage in the unit in an airworthy manner;
airworthy climate control equipment mounted on or in the unit to maintain comfortable climate control of the interior of the unit;
the unit has an electrical power converter that is connected via one or more ports disposed within a wall of the rigid parallelepipedal frame to an electrical power supply of a cargo transport aircraft when the unit is loaded into the cargo hold of an cargo transport aircraft or to another power supply when transported or on the ground;
the unit is constructed of aluminum materials;
airworthy aircraft quality, sound resistant dampening and insulation material installed in the portable modularized medical unit that reduces external noise outside of the unit during transport to an internal acoustical level of less than 75 decibels and maintains climate control; and
the dimensions and weight of the airworthy unit make it capable of being transported within the cargo hold of either an aircraft including a C-17 or a C-130 or similar transport aircraft.

2. The portable modularized medical unit of claim 1, comprising:
the longitudinal metal tracks run the entire length of the inner surface of the base structure, or they may only run the majority of the length of the base structure without completely extending from distal end to distal end of the unit.

3. The portable modularized medical unit of claim 1, comprising:
the longitudinal metal tracks run the majority of the length of the inner surface of the base structure without completely extending from distal end to distal end of the unit.

4. (canceled)

5. The portable modularized medical unit of claim 1, comprising:
a lock on the underside of the base structure of the rigid aluminum parallelepipedal frame to lock the unit into place utilizing a standard aircraft cargo handling system that is provided within the cargo hold of a cargo transport aircraft.

6. (canceled)

7. The portable modularized medical unit of claim 1, comprising:
the unit is constructed of lightweight materials.

8. (canceled)

9. (canceled)

10. The portable modularized medical unit of claim 1, comprising:
components are mounted in an airworthy manner in the unit to provide for emergency medical care.

11. The portable modularized medical unit of claim 1, comprising:
components mounted in an airworthy manner in the unit to provide for trauma care.

12. The portable modularized medical unit of claim 1, comprising:
components mounted in an airworthy manner in the unit to provide for surgical care,

13. The portable modularized medical unit of claim 1, comprising:
components mounted in an airworthy manner in the unit to provide for intensive care,′

14. The portable modularized medical unit of claim 1, comprising:
components mounted in an airworthy manner in the unit to provide for isolation care.

15. The portable modularized medical unit of claim 1, comprising:
components mounted in an airworthy manner in the unit to provide for emergency medical evacuation.

16. The portable modularized medical unit of claim 1, comprising:
components mounted in an airworthy manner in the unit to provide for exam care.

17. The portable modularized medical unit of claim 1, comprising:
components mounted in an airworthy manner in the unit to provide for mass casualty.

18. The portable modularized medical unit of claim 1, comprising:
components mounted in an airworthy manner in the unit to provide for critical care.

19. (canceled)

20. (canceled)
